(19) United States
(12) Patent Application Publication
(10) Pub. No.: US 2004/0236714 A1
(43) Pub. Date: Nov. 25, 2004

(54) Task driven taxonomy and applications delivery platform

(76) Inventors: Peter Eisenberger, Princeton, NJ (US); Iddo Wernick, Riverdale, NY (US)

Correspondence Address: KENYON & KENYON, ONE BROADWAY, NEW YORK, NY, 10004, US

(21) Appl. No.: 10/479,073

(22) PCT Filed: Jan. 24, 2003
(86) PCT No.: PCT/US03/02277

Related U.S. Application Data
(60) Provisional application No. 60/352,064, filed on Apr. 9, 2002.

(51) Int. Cl. G06F 7/00

(52) U.S. Cl. 707/1

(57) ABSTRACT

A system for receiving and transmitting data to a user includes a categorization engine to receive data from a client data source and at least one other data source, and to categorize the data by assigning a document content identifier to the data to describe a nature of the data, a data record database to receive and to store the categorized data, a structured database to receive the data from the client data source and to provide structured data, a data mapping arrangement to map the categorized data by associating the assigned document content identifier to at least one of a user class and a task supplied by the user, an application engine to apply system elements to the mapped data based on at least one of the user class and the task, and to determine a format for providing the data to the user data and a delivery arrangement to transmit data to the user.

### CROSS-REFERENCE TO RELATED APPLICATIONS

This application claims the benefit of U.S. Provisional Patent Application Ser. No. 60/352,064, originally filed Jan. 24, 2002, the disclosure of which is incorporated by reference in its entirety herein. This application also claims the benefit of and priority to co-pending U.S. patent application Ser. No. 10/006,888, filed Dec. 5, 2001, which claims the benefit of U.S. Provisional Patent Application Ser. No. 60/251,528, filed Dec. 5, 2000, the disclosure of which is incorporated by reference in its entirety.

### FIELD OF THE INVENTION

The present invention relates to a system and method for categorizing structured and unstructured data records from public and private sources and delivery of data using an applications integration system to enhance decision making and organization performance. The present invention involves applying the data to facilitate management and resource performance for commercial enterprises.

### BACKGROUND INFORMATION

It may be difficult to integrate knowledge into the decision process. It is believed that this difficulty and the importance of solving it have given rise to the field of Knowledge Management (KM). Although it is believed that progress has been made on many fronts focusing on core business functions like purchasing and accounting, the categorization of knowledge in the context of use and users may generally provide even more benefits. It is also believed that any other approaches also lack a combined information taxonomy and information delivery platform, system and method that directly connects the knowledge for the use and user to provide knowledge effectively and efficiently to decision makers. Embedding this categorized information into an electronic information delivery system that allows users to search, retrieve, and manipulate data may enable an enterprise to improve its ability to track data, evaluate alternatives, receive intelligence and act to improve performance. It is believed that the deficiencies of other approaches may be particularly apparent, for example, in efforts to connect employees from different units with an organization to enterprise-wide relevant information.

It is further believed that any such approaches may also lack the integration of knowledge relevant to organizational performance, such as, for example, environmental performance in business organizations. It is also believed that ambiguity and inconsistency may characterize the current efforts of commercial enterprises to integrate consideration of environmental quality and resource performance into standard practices, and that successful integration may have eluded businesses due to the lack of an established framework relating financial and market performance to environmental parameters. It is understood that indices relating financial performance and environmental management for public corporations have established a positive correlation between the two areas. In regard to implementation, however, it is believed that only ad hoc solutions have emerged for integrating environmental quality considerations into standard business operations. Accordingly, to address this apparent need for a more consistent approach, methodologies such as Industrial Ecology, and, more specifically, Life Cycle Assessment, may propose a framework to focus on the flow of energy and physical resources in industrial production processes. It is believed, however, that these analytic methods, as well as other methods developed for applied use in other areas, may not effectively and efficiently relate information to the decision makers because such methods do not categorize the information based on users and how they may use the information. Furthermore, such methods may not effectively integrate the information into a delivery system.

### SUMMARY OF THE INVENTION

An exemplary system and method of the present invention may categorize information and data based upon technical criteria relevant to accomplishing an objective of an organization, such as, for example, a regulatory or performance objective of a commercial, government/public, or NGO organization. In this regard, the information critical to the organization may be efficiently provided so that decisions may be made more effectively. The information may be collected from public and private sources and categorized according to a predefined set of identifiers that describe the nature of the data and its relevance to the organization and/or the organizational task to be achieved. The data may then be assigned to one or more classes of users, which may be defined by a group of individuals sharing a common industry, role, business objective, or other common associated attribute. Based on feedback from the users concerning the nature of the data records, the correlation of data records with user classes may be continuously upgraded.

It is believed that exemplary embodiments and/or exemplary methods of the present invention may be distinguished from any other approaches referred to above in that data entering the system may be categorized by how it is used, by whom it is used, and for what purpose it is used. In this regard, the categorization may be task-driven. Thus, information may be categorized according to the objectives of the user, rather than by the non-contextual informative nature of the data, which may vastly improve the effectiveness of information delivery by connecting the proper decision maker with the appropriate knowledge.

An exemplary system and method of the present invention are also believed to provide for categorizing internal corporate information, as well as information from external sources, based on technical criteria relevant to, for example, the production of goods and services and the standard business objectives of a commercial enterprise. In this regard, the exemplary system and method may receive and categorize information of interest to decision makers in a wide variety of disciplines for applied use in nearly all areas of commercial and non-commercial enterprise. For example, the present invention may address the business objectives of commercial users such as Regulatory Compliance, Resource Optimization, Risk Management, Product Design, Supply Chain Management, Corporate Strategy and Communications. Other enterprises with other objectives may be similarly addressed as well.

Using the exemplary system and/or the exemplary method, information and knowledge in the form of data records may be rendered searchable and retrievable based on a uniform, comprehensive meta-data scheme, in which retrieved data in the form of data records is categorized according to a predefined set of document content identifiers (DCIs) which are associated with one of more classes of users. The categorized data records may reside on local or remote databases and may be in the form of statistical charts, reports, research articles, technical reviews, business case studies, financial and accounting tables, vendor lists, internal correspondence and financial market information.

According to an exemplary embodiment and/or exemplary method of the present invention, data records may be delivered to users by proprietary applications that have been developed as part of the software platform or linked to from third party Internet-based-applications providers. The data records may be delivered to the decision makers at various stages of the decision making process, including, for example, during measurement, analysis, assessment, and/or implementation. The delivery platforms (herein referred to as System Elements) may include but are not limited to News, Research, Metrics, Experts, Workflows, Company Documents, Tools, Discussion Forums, and Reports. The categorized data and applications may be accessed through an Internet-accessible password-protected private network. The delivery system of the data/information is also described in related U.S. Provisional Patent Application Ser. No. 60/251,528, entitled “System and Method for Providing Data for Decision Support”, filed on Dec. 5, 2001, which is incorporated herein by reference.

The exemplary embodiment and/or exemplary method according to the present invention may also provide a taxonomical system including, for example, three meta-taxonomies and the organizational logic that connects them to enable the optimal delivery of information to the decision makers whose decisions may critically impact an organization, such as, for example, a decision that affect business performance. The meta-taxonomies may contain one or more hierarchical information taxonomies and each individual taxonomy may be multi-tiered. The sub-structures comprising these tiers and the individual terms populating the tiers may be modified dynamically in response to user feedback. The meta-taxonomies may provide a system for characterizing data records and for enabling their integration with the business operations of a commercial enterprise.

The exemplary meta-taxonomies may apply to data records, users, and information delivery applications, and are referred to as Document Content Identifiers (DCIs), System Elements and User Classes. Using DCIs for complementary data description may allow for more powerful characterization of data records, the ability to leverage automated data categorization applications that rely on orthogonal categories for content description, and the targeted delivery of the information to the users. The relational maps relating the individual elements in the meta-taxonomies may associate a particular class of business users with a subset of knowledge, i.e., DCI combinations, as determined by domain experts. The map relating information categories with the user classes is referred to as a Meta-data Map. The taxonomical information, i.e., DCI combinations, associated with the individual data records that include that subset of knowledge may be integrated with further data by an application integration engine that determines the information delivery format of data records to the user to maximize their value. The integration of related data records to the system elements in the application integration engine may produce optimized meta-data that benefits the user.

While the exemplary embodiments and methods are described for applied use for commercial enterprises with an emphasis on environmental related decisions, the present invention may also be applied for other enterprises with decisions based on other objectives as well.

### DESCRIPTION OF DRAWINGS

FIG. 1a shows an exemplary embodiment of a system that provides users with relevant data without requiring the query of the information from the users.

FIG. 1b shows an exemplary method performed by the system of FIG. 1a.

FIG. 1c shows exemplary operations to categorize data.

FIG. 1d shows exemplary operations to integrate data.

FIG. 2 shows an exemplary method of applying document content identifiers.

FIG. 3 shows an exemplary method of integrating data.

FIG. 4 shows an exemplary material flow and associated document content identifiers.

FIG. 5 shows an exemplary structured content from a public source.

FIG. 6 shows an exemplary unstructured content from a public source.

FIG. 7 shows an exemplary unstructured content from a private source.

FIG. 8 shows an exemplary unstructured content from a client data source.

FIG. 9 shows an exemplary structured content from a client data source.

FIG. 10 shows an exemplary structured content from a private data source.

FIG. 11 shows an exemplary meta-data mapping of document content identifiers to user class.

### DETAILED DESCRIPTION

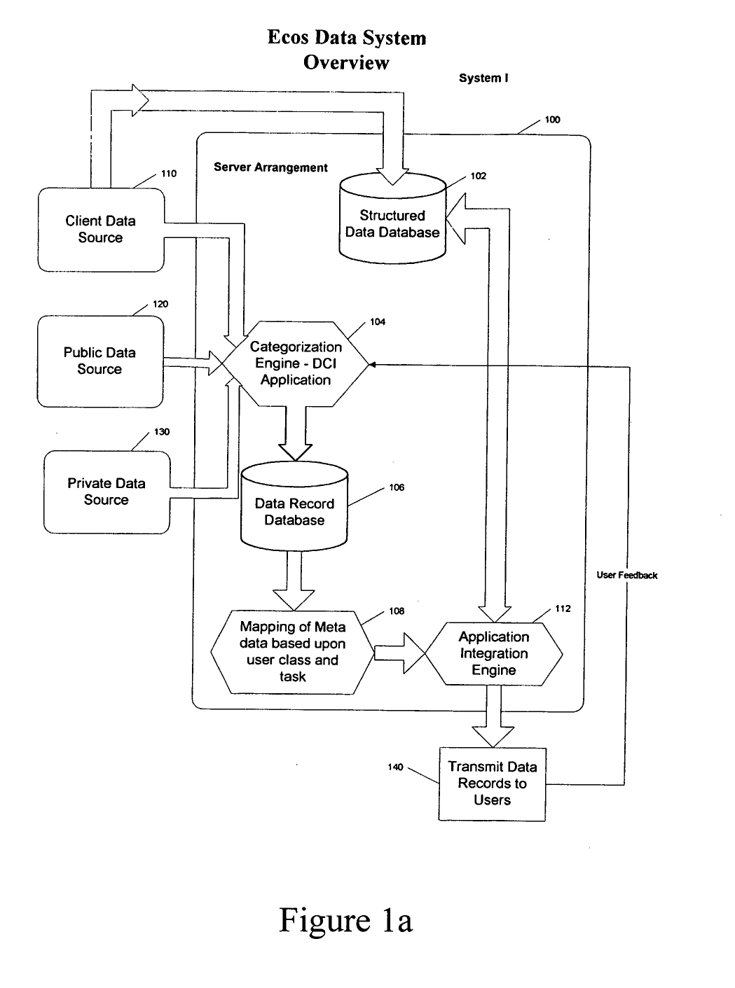

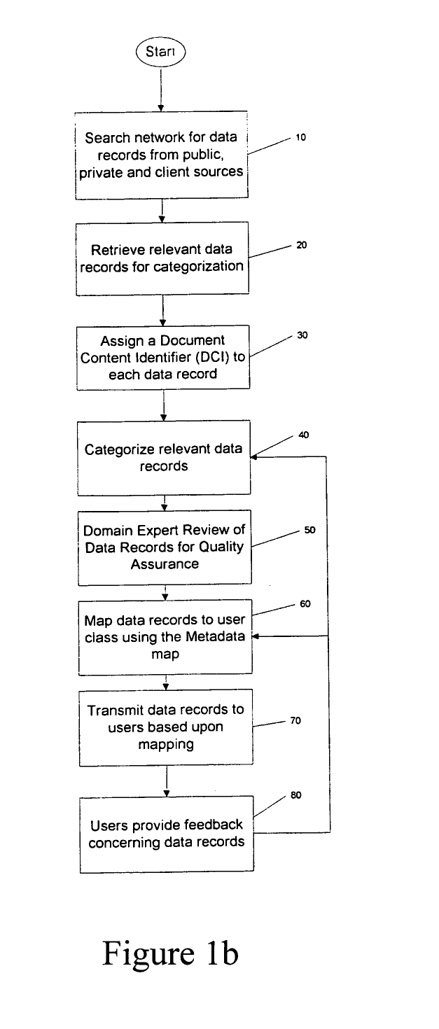

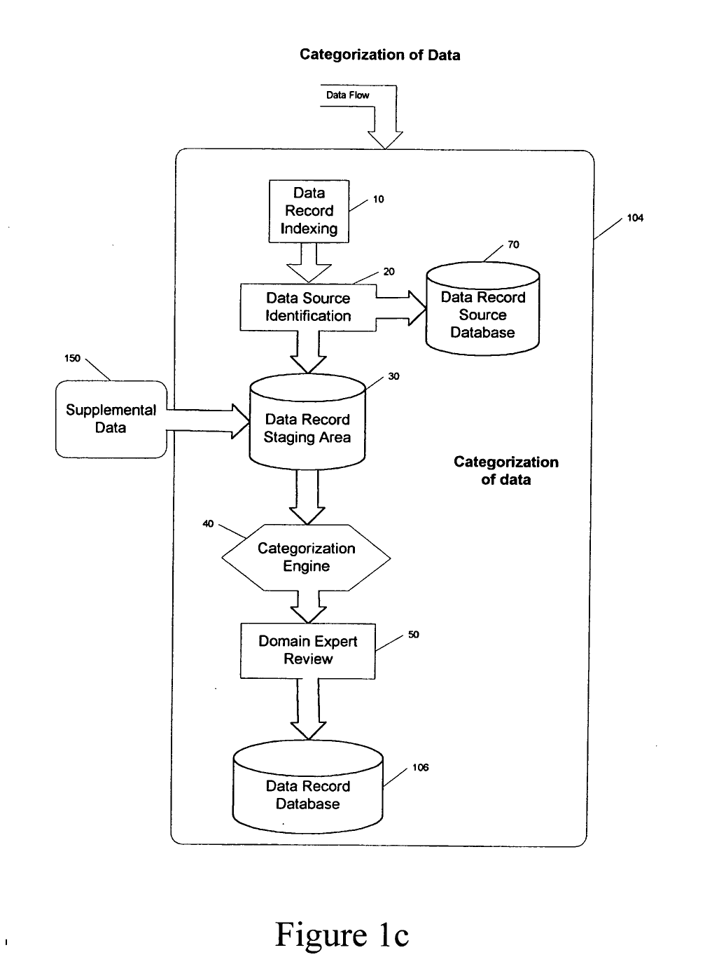

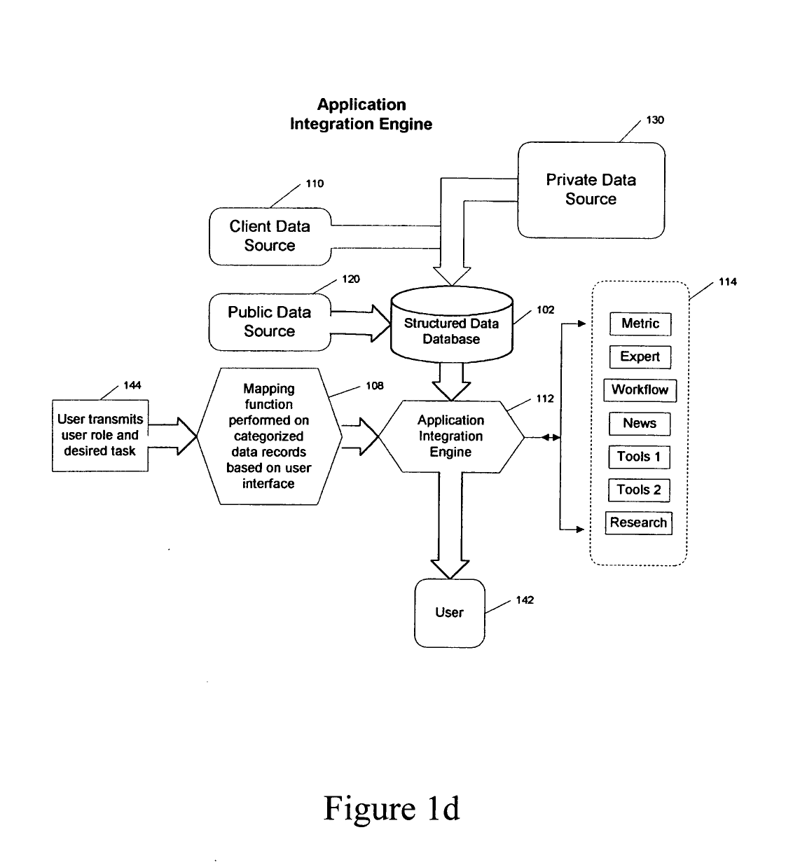

FIG. 1a shows an exemplary embodiment of a system 1 that provides users with relevant data without requiring the query of the information from the users. The system 1 includes a server arrangement 100 that continuously retrieves data from various sources and stores it in the form of categorized data records. Upon retrieval of the data, the server arrangement 100 assigns at least one Document Content Identifier (DCI) to each data record and transmits the DCI assigned data record to a domain expert arrangement for review. The domain expert, which may be software, reviews the DCI assignments, supplements or changes the DCI assignments, and enhances the format and content of the data record if necessary. Users may then retrieve relevant data records via an access device, such as, for example, a desktop computer, a laptop computer, a personal data assistance (PDA), and/or via an intermediary communications network, such as, for example a public switched telecommunications network or a private cellular network.

The server arrangement 100 assigns each user to a user class based upon information provided by the user upon initial connection to the server arrangement 100. After initial user class assignment, the user may elect to join other user classes and/or update its association during subsequent use. The server arrangement 100 may provide each user sufficient access so that each user may gain an understanding of how information within the data records relates to DCIs, how DCIs are assigned to data records, and which DCIs are of interest to which users.

The server arrangement 100 may receive data from various data sources including a client data source 110, a public data source 120 and a private data source 130. The client data source 110 includes data from registered client members who may allow access to databases residing in the respective client member's domain or the client member may stream designated data upon request by domain experts who facilitate the operation of the system 1. Public data source 120 includes data that may be obtained, for example, via web crawling software and searches initiated by domain experts. Public data may come from various readily and freely accessible sources, such as the worldwide web, public access networks and public accessible intranets. Private data may include databases residing within private domains, such as, for example, Local Area networks (LANs), Virtual Private Networks (VPNs), which allow the domain experts access specifically for supplementing the system 1. The client data source 110 may also supply statistical data for storage on structured data database 102.

A categorization engine 104 receives the data from the client data source 110, public data source 120, and private data source 130 and applies Document Content Identifiers (DCI's) to the data, which are loaded into the data record database 106. The categorization engine 104 processes meta-data from the data record database 106. Upon request by a user, mapping engine 108 maps data residing on data record database 106 based solely upon the user class and task as input by the user. The user interface initiates the meta-data mapping arrangement 108 and the application integration engine 112, which applies systems elements, structured data from database 102 and supplemental structure data from the user to correlate the data based on the user class and/or task. The user receives a complete set of relevant, enhanced, and manipulated data to assist in decision making, planning and strategic analysis.

FIG. 1b shows an exemplary method performed by the server arrangement 100. In step 10, the server arrangement 100 initially performs a comprehensive network search of predetermined public websites, designated content providers and customer information systems to capture data records, such as, for example, articles, reports, statistics, graphs, white papers. In step 20, the server arrangement 100 retrieves the data records based on initial gross filtering criteria that may include a selection of data sources, as well as keywords in order to include/exclude data records. In this manner, the gross filtering helps to determine the relevancy of the data record within the domain being searched. After the data records are retrieved, the categorization engine 104 assigns a set of DCIs to each data record in step 30. Some unstructured data records may require manual assignment of DCIs as described below as to review by the domain expert in step 50. In step 40, the relevant data records are categorized for storage in the data record database 106 by establishing a companion table for each data record with fields that correspond to each DCI category. In step 50, a domain expert arrangement (which may be in the form of specialized software) may review each data record for quality assurance to eliminate poor quality data records and to refine previous data record categorization. The domain expert is intended to at least better ensure the accuracy of DCI assignments and/or enrich the content of the data record to make it more useful for users. In step 60, the data records are mapped to user classes based upon the expert's understanding of a user role to develop and apply a custom set of DCIs relevant to that user role (Meta-data Map). Upon the completion of meta-data mapping, the server arrangement 100 transmits data records through applications that deliver data records based on the user class in step 70. If elected by the user, the data records may be periodically sent directly to users who desire automatic transmittal of the data record via electronic mail. Data records are also available to a user upon connection to the server arrangement. In step 80, users may provide feedback through e-mail or other standard user surveys that evaluate the relevance of the data retrieved by the system as well as the desirability of additional types of data records to enable improved categorization and mapping functions.

Under the domain expert review, unacceptable data records may be discarded and a meta-data scheme may be created to map Document Content Identifiers to user classes. In particular, the DCIs are mapped to a particular user class, which may be defined as a group sharing a common industry, role and business objectives. Once the data records have been assigned a particular DCI, those data records are directed to a user based on the Meta-data that maps DCIs to user classes.

If the user class includes a large number of users, then further efficiencies may be realized since these steps only need to be performed once for each user class. Furthermore, if the DCIs are of interest to many user classes, then by identifying information related to the DCI for the initial user class, the system simultaneously begins the process of developing the capability to deliver information to another user class with similar interests. By leveraging established sets of DCIs one may quickly converge, so the addition of user classes may require little effort.

It is believed that the exemplary method outperforms other methods because the connection of users with relevant data records primarily involves routing and not searching. In this context, the meta-data mapping, which relates DCIs to users according to their industry, role, and business objectives, may provide a valuable corporate tool. Because users are identified with the same informational needs, the system may achieve even greater efficiency if users provide feedback along with their evaluation of the data records and offer new data sources they may discover during the course of their work. For example, a user, such as a process manager, may receive a data record related to information concerning a new process improvement and thus may immediately share this new information with other users in the same user class. Upon receipt of any new information, the system may delete any data records considered to be outdated from the database based on the feedback from users.

FIG. 1c shows an overview of exemplary operations related to categorization of data records. Such operations may be used, for example, to categorize data records according to the environmental and business relevance in the context of the exemplary meta-taxonomies and organization logic relating them to one another. In FIG. 1c, data flow 115 represents the flow of data from the data sources as shown in FIG. 1a.

The operations related to categorization include performing data record indexing 10, which involves the application of document content identifiers (DCI's) and content meta-data categories (CMC's). Additionally, the source of the data may be identified 20 and stored in the data record source database 70. After application of the DCI's and any applicable CMC's, the data records are held in data record staging area 30 prior to being fed into a categorization engine 40. The data record staging area 30 receives supplemental data 150 to further enrich the data records prior to categorization. The supplemental data may include, for example, data received from user feedback and other third party content providers. The categorization engine 40 categorizes the data records based upon the DCI's and CMC's that are associated with respective data records. After categorization, the data records are placed in a queue for review by the domain expert arrangement 50 so that the data records may be reviewed for accurate content and proper DCI application. After completion of the domain expert review, the data records are stored in the data record database to await mapping commands for specific use request as generated by the mapping engine 108. Table A is a list of DCI's that may be assigned to the data records.

TABLE A
Exemplary DCI's

| | |
|---|---|
| 1. | Content_ID |
| 2. | Entry_Date |
| 3. | Display_Name |
| 4. | Author |
| 5. | Creation_Date |
| 6. | Keywords |
| 7. | Description |
| 8. | Filename |
| 9. | System_Element_Type |
| 10. | Presentation Layer Identifier |
| 11. | Data Source |
| 12. | Actual_Date |
| 13. | Expert_Email |
| 14. | First_2000 |
| 15. | Period_Covered |
| 16. | Has_Target |
| 17. | Individual_Or_Group |
| 18. | Has_Benchmark |
| 19. | Resources |
| 20. | Environment_Stewardship |
| 21. | Process |
| 22. | Issues |
| 23. | Industry_Sector |
| 24. | Geography |

Appendix I provides an exemplary list of CMC's. Appendix II provides an XML chart, which depicts an exemplary list of DCI applications. The DCI applications of Appendix II show various exemplary taxonomy hierarchies that may be applied to the data records. The following Table B is an exemplary list of user classes.

TABLE B
Exemplary User Classes

| | |
|---|---|
| 1. | Accounting |
| 2. | Community Relations |
| 3. | Extremely Hazardous Substances (EHS) (senior manager) |
| 4. | Energy-process/operations |
| 5. | Energy-procurement |
| 6. | Environmental Marketing Communications |
| 7. | Facilities Manager |
| 8. | Facility Safety |
| 9. | Finance - capital investment |
| 10. | Green House Gases (GHG) |
| 11. | Hazardous Material mgt. |
| 12. | Information Systems |
| 13. | Investor Relations |
| 14. | Labor Relations |
| 15. | Legal |
| 16. | Materials-design/process |
| 17. | Materials-procurement |
| 18. | Product Stewardship |
| 19. | Regulatory Compliance - Air |
| 20. | Regulatory Compliance - Land |
| 21. | Regulatory Compliance - Water |
| 22. | Risk Management |
| 23. | Solid Waste mgt. |
| 24. | Supply Chain |
| 25. | Worker Health |

A subset of these DCI's is applicable to only specific system elements on the delivery platform. Specifically, DCI's 15-18 refer to the system elements metrics and reports, DCI 13 applies to the system element experts and DCI 14 applies only to the system element reports. The other DCI's are uniformly applicable across for all of the data types retrieved from data repositories and applications embedded in the system. A subset of the DCI's is mandatory for indexing data records. The majority of DCI's however may be used as necessary for providing efficient data record categorization and system retrieval.

FIG. 1d shows an overview of the functions related to the application integration engine 112. The application integration engine 112 is triggered by user interface with server arrangement 100. A user transmits an assigned user class and a desired task. For exemplary purposes, a facilities manager may desire to implement energy saving equipment and may therefore need data showing typical energy demands at similar facilities, reviews regarding state of the art equipment, governmental incentives and/or regulations and relevant statistical data from manufactures and other facilities. The mapping engine 108 maps all pertinent data for the facilities manager and the application integration engine 112 supplements and potentially analyzes the meta-data by searching the structured database and assigning system or work elements 114 to the mapped data. The application integration engine 112 is operable to retrieve raw statistical data from the structured data database 102 and to transmit the raw data to the user, or the application integration engine 112 may further manipulate and analyze the raw data to place it in proper form for this user. The application integration engine 112 uses the mapped data generated by the mapping engine 108, the structured data and applies system elements 114 to deliver the current, accurate and effective data to assist the user in effectuating the task as submitted by the user.

In the exemplary embodiments and/or exemplary methods of the present invention, users access data and manipulate data drawing on data repositories and applications embedded in the system. The data record delivery format uses the application integration engine 112 to associate data records with one or more system elements based on logic embedded in the system. Table C provides an exemplary list of system elements 114.

TABLE C
System Elements

| | |
|---|---|
| 1. | News |
| 2. | Research |
| 3. | Metrics |
| 4. | Experts |
| 5. | Workflows |
| 6. | Company Documents |
| 7. | Tools |
| 8. | Discussion Forums |
| 9. | Reports |

The following is a detailed description of the system elements 114.

News system elements are generated by external sources and include data records about recent events or happenings, especially as reported by newspapers, periodicals, radio, or television. News may be distinguished from Research by the time-sensitive nature of the content, the currency of the content, and designation of the content provider as a news source (e.g., AP, Reuters, etc.). News system elements are primarily stored in the file system and may be delivered to the user in HTML, JSP, or other browser format. News items are categorized using the Content Meta-data categories, as well as the following DCIs: Creation_Date, System_Element_Type, and Source.

Research system elements include intelligence from external sources that offer a resource for decision-support. Research system elements may be stored in HTML, PDF, MS Word, MS Excel formats and may be delivered to the user as in HTML, JSP, or other browser format. Research system elements may rely on the Content Meta-data categories for categorization and also may use the following DCIs: Creation_Date, System_Element_Type, and Source.

Metrics are system elements that represent the result from a mathematical expression composed of operations on one or more measures. Measures consist of structured data records received from clients and other third parties that contain statistical information that may be transitory or persistent, and are categorized using the Content Meta-data Category DCIs as well as other meta-data that enable efficient data extraction, transformation and loading from client systems. Metrics may be stored in the file system in the data format of the application used for their creation and can be delivered to the user as in HTML, JSP, or other browser format. Metrics are categorized using the Content Meta-data categories as well as the following DCIs: Author, Creation_Date, System_Element_Type, Description, Period_Covered, Has_Target, Individual_Or_Group, and Has_Benchmark.

Reports are user-generated files on the platform that document the results of the user's data retrieval and analysis. Reports are stored on the platform in a file system and may be delivered to the user as in HTML, JSP, or other browser format. Reports may include other system elements such as metrics well as pointers to experts, forums, and research data records. Reports may contain data as statistical charts, text, graphical images and other data formats. Reports are categorized using the Content Meta-data categories as well as the following DCIs: Author, Creation_Date, System_Element_Type, and First_2000 words of the report body.

Experts refer to individuals or organizations to which a user has access that provide domain knowledge relevant to addressing a user identified business need. Expert data records are stored on the platform in a file system and may be delivered to the user as an HTML page on the user's browser. Experts are categorized using the Content Meta-data categories as well as the following DCIs: Expert_Email, System_Element_Type, Description, and Source.

Workflows are system elements that guide users through a sequence of steps/events involving predetermined and user-selected system elements to accomplish a specified business task. Each step/event uses data generated by a previous step/event and provide information to the next step/event. Each step/event represents a Boolean search for appropriate data records and the determination of which system element should be used for data delivery to the user. Workflows may be stored as HTML pages and are categorized using the Content Meta-data categories as well as the following DCIs: System_Element_Type, Description and other DCIs inherited from component system elements.

Company documents refer to files uploaded directly by the user to the platform data storage area. Company documents may be stored in HTML, PDF, MS Word, MS Excel formats in the file system and may be delivered to the user as an HTML page on the user's browser. Company Document data records rely on the Content Meta-data categories for categorization and also must use the following DCIs: Creation_Date, System_Element_Type, and Author.

Discussion Forums are system elements that offer users a platform to participate in online discussions with experts and colleagues within and outside their company on subjects relevant to improved corporate environmental performance. Forums may be stored in HTML, JSP or other browser format, for delivery to the user as, for example, an HTML page on the user's browser. Company Document data records use the Content Meta-data categories for categorization and also must use the following DCIs: System_Element_Type and Description.

Tools are applications developed as part of the platform or from third party providers that enable computation, analysis, sharing, and presentation of structured data. Tools are stored in the file system and are activated based on user selection or by virtue of being one component of a workflow system element. Tools may be stored as JSP pages or other in another browser format, for delivery to the user's browser. Tools use the Content Meta-data categories for categorization and also must use the following DCIs: System_Element_Type and Description.

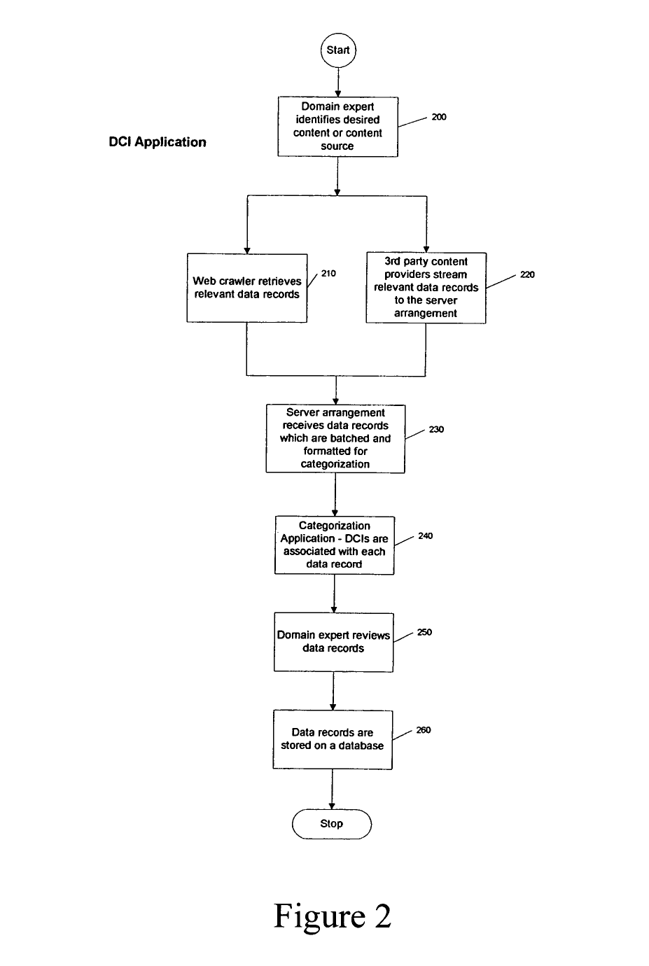

FIG. 2 shows an exemplary method for a DCI application. To create a suitable and current database, a domain expert identifies the desired content or content sources, step 200. The domain expert interfaces with the server arrangement 100 to initiate the retrieval of data records. The domain expert sets search parameters for the proprietary search and contacts third party content providers who provide data records upon request. For example, two simultaneous steps may occur during the retrieval of data: 1) a web crawler automatically retrieves data records from the three sources as shown in FIG. 1a as in step 210; and 2) requests are sent to third party content providers who stream any relevant data records to the server arrangement as in step 220.

The server arrangement initially batches and formats the data records for categorization purposes, step 230, where DCI's and CMC's are associated with each data record. To maximize the effectiveness of the categorization application, the system is configured to categorize system elements individually for each content meta-data category. Within each CMC, the categorizer application may allow, for example, up to a maximum of 3 taxonomy terms that exceed a predetermined threshold value to be assigned to an individual system element. Applying those DCI's relevant to a given data record within each of the CMC's may allow for powerful complementary description of the underlying data. After categorization, domain experts review the DCI application results to better ensure accuracy and may execute supplemental applications.

An exemplary embodiment of the present invention uses an enhanced industrial ecology model for data categorization and delivery. The CMC's form the content taxonomy, where its structure is intended to optimize or at least improve the value of data for decision making that impacts corporate environmental performance in terms of physical resource productivity and pollution generation. The content taxonomy addresses the need for enterprises to combine statistical information and business intelligence for tracking data, evaluating alternative technologies, and appreciating their market and regulatory context.

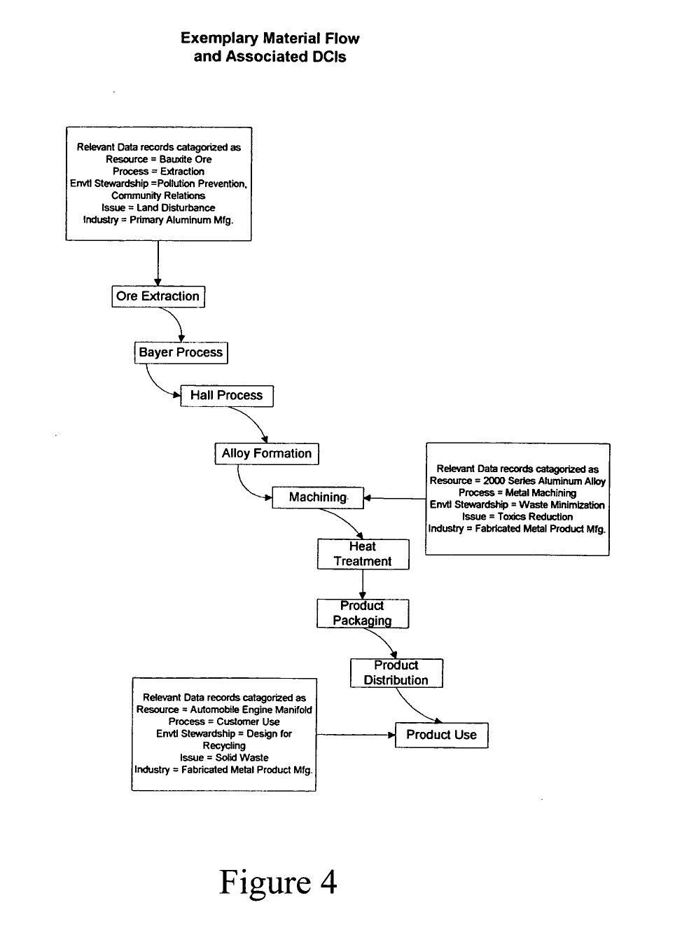

The primary CMC's are from the following categories: Resources, Environmental Stewardship, Process, Issues, and Industry. The Resources category provides a comprehensive framework for characterizing physical and financial resources used to produce business value. The Environmental Stewardship category provides a comprehensive framework for characterizing the managerial and market relevance of a resource to produce business value. The Process category provides a comprehensive framework for identifying where a resource is used within a corporate framework. The Issues category provides a comprehensive framework for characterizing the political and social context of the resource and process used and the Environmental Stewardship objective sought. The Industry Sector category identifies the relevant industry(ies) for the use of a given resource in a given process. FIG. 4 shows the basis for applying a given set of CMC DCI's to a given data record and illustrates the assured relevance of data categorization using the exemplary embodiments and/or exemplary methods of the present invention.

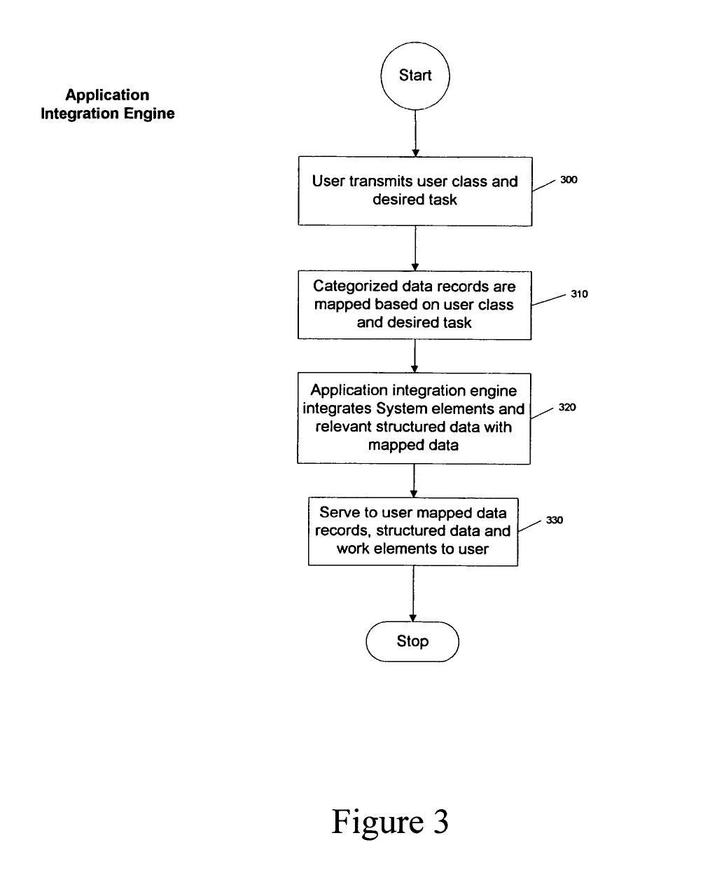

FIG. 3 shows an exemplary method associated with the application integration engine 112. As described above in regard to FIG. 1d, a user interfaces with the server arrangement and inputs a user class and desired task, step 300. Categorized data records are then mapped based solely on the user class and task without any substantive query by the user, step 310. Next, the application integration engine 112 integrates system elements and any relevant structured data, with the mapped data, step 320. The complete meta-data is structured to the user to assist the user performing the designated task.

FIG. 4 shows an exemplary material flow and how DCI's are associated with the processes along the material flow. As shown, any data records associated with the extraction step may include DCI's associated with resource, process, stewardship, a designated issue and/or industry type. Other DCI associations are shown for the machining and product use steps, as shown, similar CMC's may be associated with different steps along the material flow. The DCI's shown in FIG. 4 are different for each step. However, other material flows or applicable tasks may include different DCIs.

Data records are stored in the data record database 106 for mapping purposes as described above. The data records include six generic forms, structured public, private and client data, and/or unstructured public, private and client data.

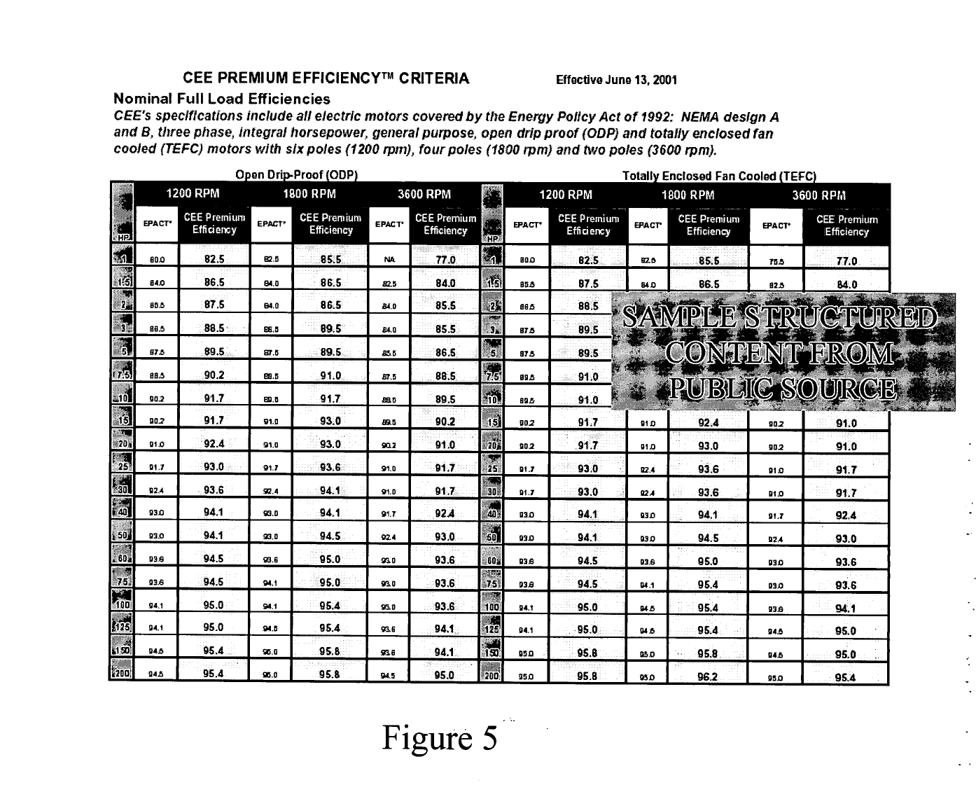

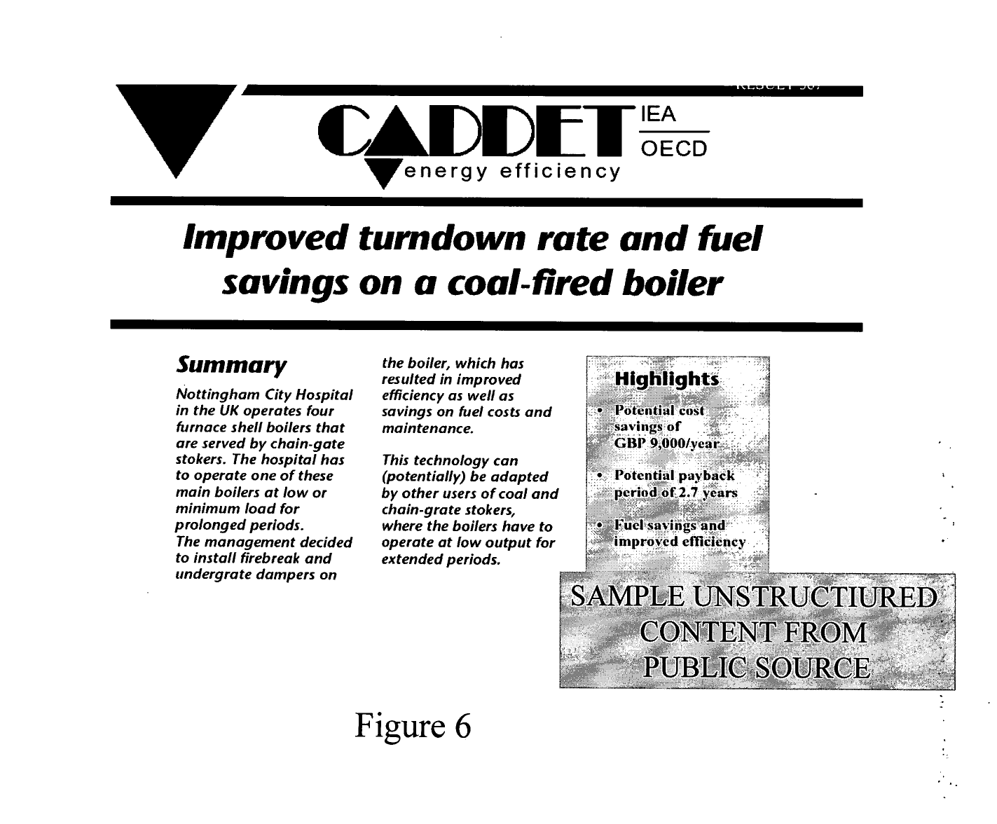

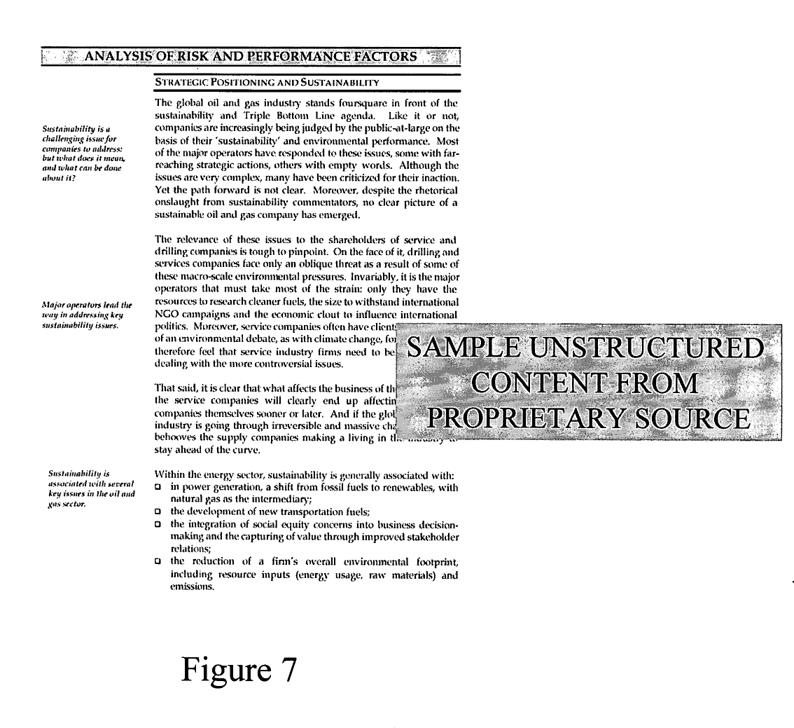

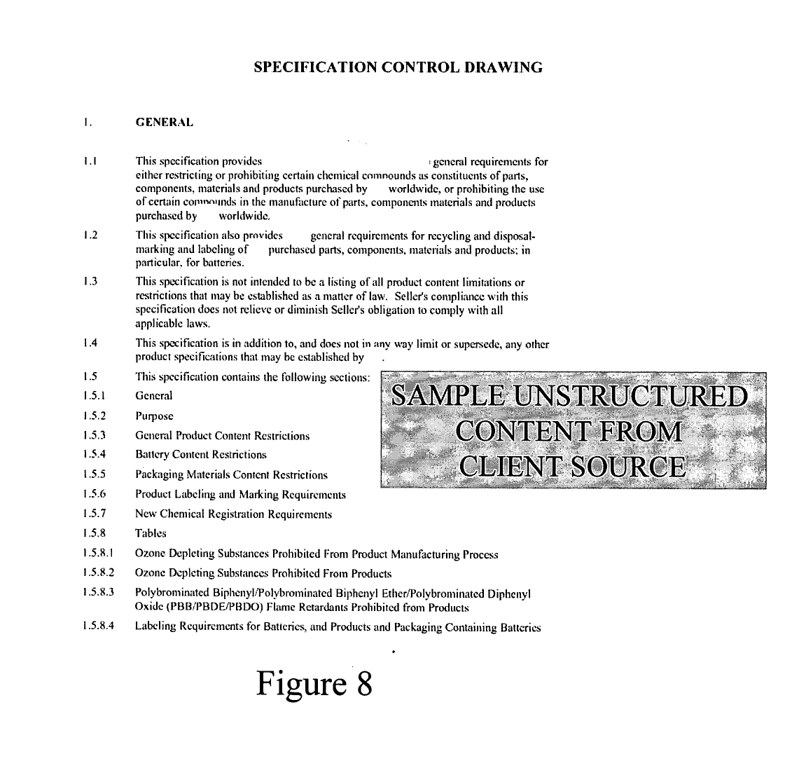

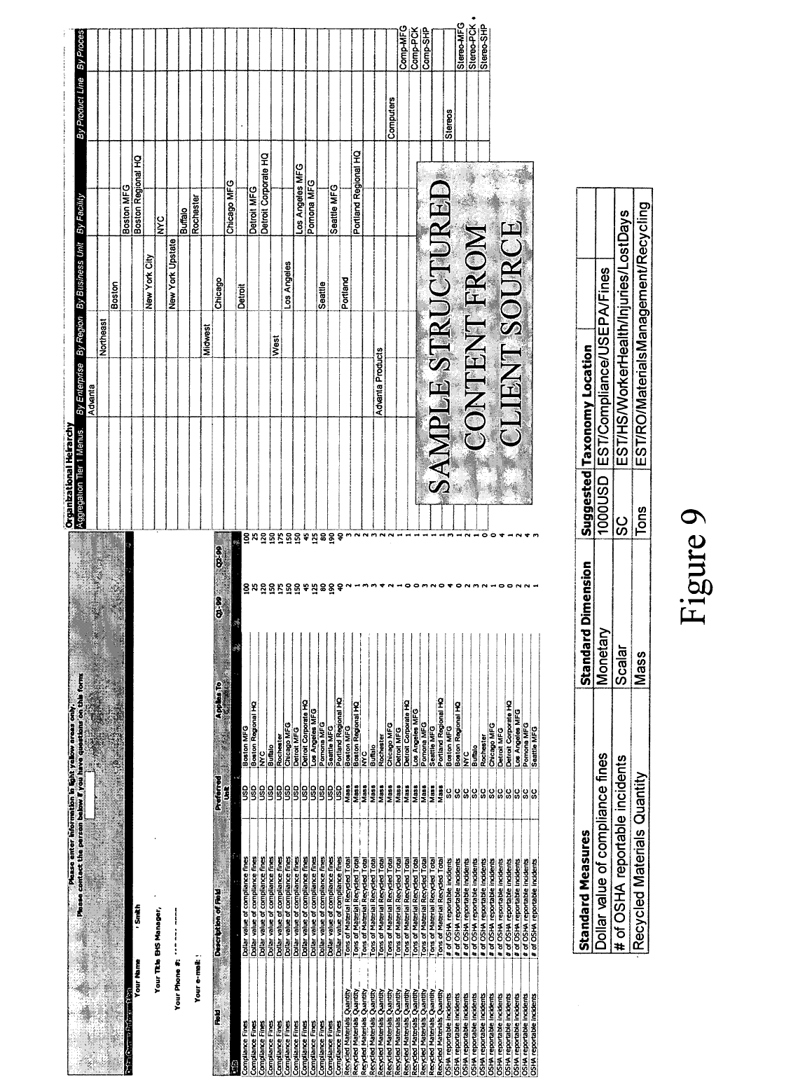

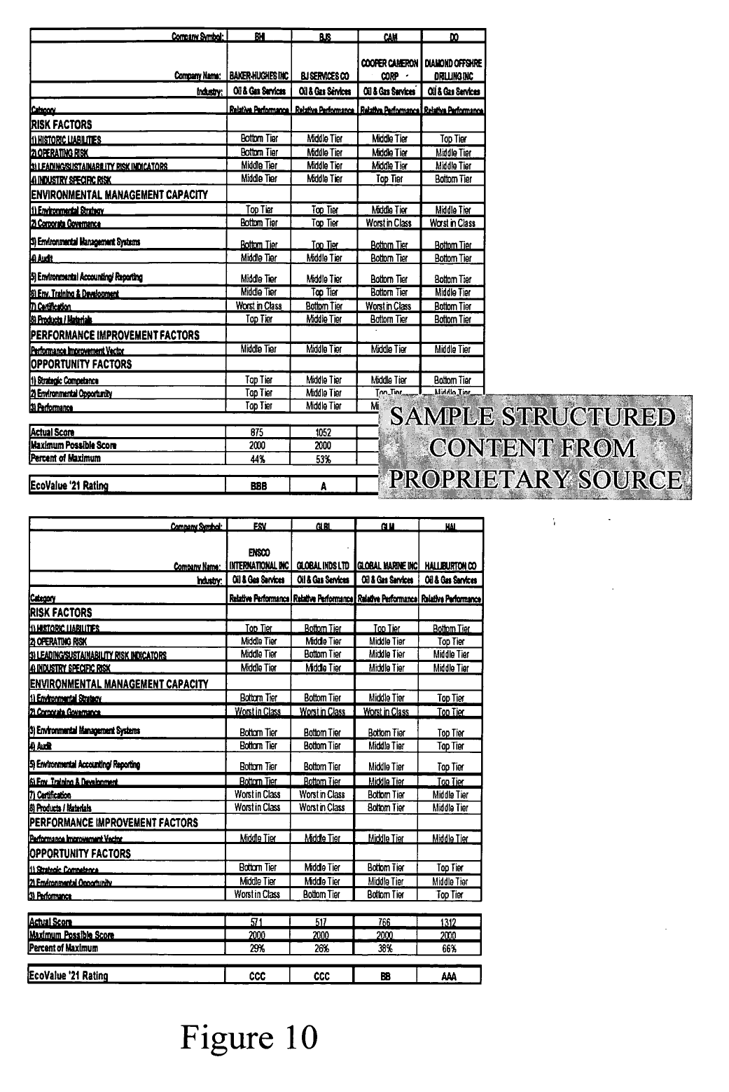

FIGS. 5 to 10 show exemplary data records that may be stored on the data record database. In particular, FIG. 5 shows an exemplary data record including structured content from a public source, FIG. 6 shows an exemplary data record including unstructured content from a public source, FIG. 7 shows an exemplary data record including unstructured content from a private source, FIG. 8 shows an exemplary data record including unstructured content from a client data source, FIG. 9 shows an exemplary data record including structured content from a client data source, and FIG. 10 shows an exemplary data record including structure content from a private data source.

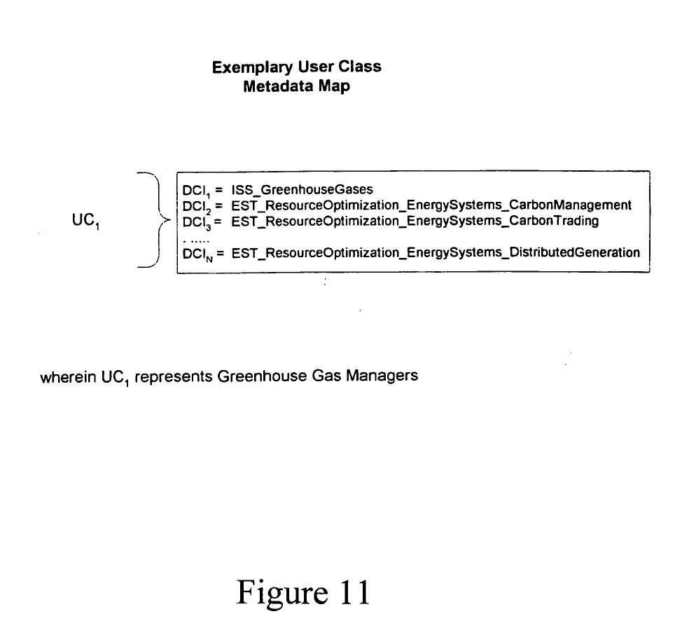

FIG. 11 shows an exemplary mapping of DCIs to a first user class UC₁ representing Greenhouse Gas Managers as an exemplary user class member. The DCIs listed in FIG. 11 are shown as linked to first user class UC₁, accordingly any data records which are assigned the DCIs listed in FIG. 11 are mapped to the first user class UC₁. Users who are members of first user class UC₁ receive data records that are assigned the DCIs which have been mapped to the first user class UC₁.

### Appendix I Exemplary CMC's

EST

EST/Compliance

EST/Compliance/EU

EST/Compliance/EU/Regulations

EST/Compliance/Intl

EST/Compliance/Intl/Regulations

EST/Compliance/OSHA

EST/Compliance/OSHA/Fines

EST/Compliance/OSHA/Permits

EST/Compliance/OSHA/Regulations

EST/Compliance/USDOL

EST/Compliance/USDOL/Fines

EST/Compliance/USDOL/Permits

EST/Compliance/USDOL/Regulations

EST/Compliance/USDOT

EST/Compliance/USDOT/Fines

EST/Compliance/USDOT/Permits

EST/Compliance/USDOT/Regulations

EST/Compliance/USEPA

EST/Compliance/USEPA/ControlTechnology

EST/Compliance/USEPA/Fines

EST/Compliance/USEPA/Permits

EST/Compliance/USEPA/Regulations

EST/Compliance/USEPA/TRI

EST/Compliance/USStateEPA*

EST/Compliance/VoluntaryStandards

EST/Compliance/VoluntaryStandards/GEMI

EST/Compliance/VoluntaryStandards/GHGProtocol

EST/Compliance/VoluntaryStandards/GRI

EST/Compliance/VoluntaryStandards/ISO 14000

EST/CSC

EST/CSC/CommunityRelations

EST/CSC/CommunityRelations/Global

EST/CSC/CommunityRelations/Global/Contributions

EST/CSC/CommunityRelations/GlobalNolunteer

EST/CSC/CommunityRelations/Local

EST/CSC/CommunityRelations/Local/Contributions

EST/CSC/CommunityRelations/Local/Volunteer

EST/CSC/CorporateEnvironmentalReporting

EST/CSC/CorporateEnvironmentalReporting/FinancialMarkets

EST/CSC/CorporateEnvironmentalReporting/Quality

EST/CSC/CorporateEnvironmentalReporting/Social

EST/CSC/EnvironmentalAward

EST/CSC/EnvironmentaiMarketOpportunities

EST/CSC/EnvironmentalMarketOpportunities/EmissionsMarkets

EST/CSC/EnvironmentalMarketOpportunities/EnvironmentalValuation

EST/CSC/FinancialPlanning

EST/CSC/GovernmentRelations

EST/CSC/InvestorRelations

EST/CSC/LaborRelations

EST/CSC/Legal

EST/CSC/TechnologyPlanning

EST/HS

EST/HS/FacilitySafety

EST/HS/FacilitySafety/BuildingSafety

EST/HS/FacilitySafety/BuildingSafety/FirePrevention

ESTIHS/FacilitySafety/EmergencyResponse

EST/HS/FacilitySafety/Plans

EST/HS/FacilitySafety/SafetyEquipment

EST/HS/FacilitySafety/Spills

EST/HS/FacilitySafety/Training

EST/HS/WorkerHealth

EST/HS/WorkerHealth/AccidentPrevention

EST/HS/WorkerHealth/Ergonomics

EST/HS/WorkerHealth/Ergonomics/Lifting

EST/HS/WorkerHealth/Ergonomics/RepetitiveMotion

EST/HS/WorkerHealth/IndoorAirQuality

EST/HS/WorkerHealth/Injuries/LostDays

EST/HS/WorkerHealth/MSDS

EST/HS/WorkerHealth/ProtectiveEquipment

EST/HS/WorkerHealth/Training

EST/HS/WorkerHealth/WorkersCompensation

EST/PD

EST/PD/Process

EST/PD/Process/ByproductReuse

EST/PD/Process/EnergyProductivity

EST/PD/Process/LaborProductivity

EST/PD/Process/SecondaryMaterialUse

EST/PD/Process/ToxicReduction

EST/PD/PS

EST/PD/PS/DesignforDisassembly

EST/PD/PS/DesignforRecycling

EST/PD/PS/EnergyConsumption

EST/PD/PS/PackagingOptimization

ESTIPD/PS/PackagingOptimization/PrimaryPackaging

EST/PD/PS/PackagingOptimization/SecondaryPackaging

EST/PD/PS/ProductDistribution

EST/PD/PS/ProductSafety

EST/PD/PS/RecycledContent

EST/PD/PS/Sales/Marketing

EST/PD/PS/Sales/Marketing/EnvironmentalCertification

EST/PD/PS/Sales/Marketing/GreenMarketing

EST/PD/PS/Sales/Marketing/ProductDifferentiation

EST/PD/PS/Sales/Marketing/ProductTakeback

EST/PD/PS/ToxicContent

EST/PP

EST/PP/AirPP

EST/PP/AirPP/Fugitiveemissions

EST/PP/AirPP/Stackemissions

EST/PP/AirPP/Upstreamemissions

EST/PP/HazardousMaterialsMinimization

EST/PP/HazardousMaterialsMinimization/Alternativematerials

EST/PP/HazardousMaterialsMinimization/Alternativeprocesses

EST/PP/WaterPP

EST/PP/WaterPP/WastewaterTreatment

EST/PP/WaterPP/WaterRecirculation

EST/ProcurementSCEM

EST/ProcurementSCEM/NonProductionGoods

EST/ProcurementSCEM/NonProductionGoods/Maintenance

EST/ProcurementSCEM/NonProductionGoods/Operations

EST/ProcurementSCEM/NonProductionGoods/Repair

EST/ProcurementSCEM/NonProductionGoods/Services

EST/ProcurementSCEM/NonProductionGoods/Vendors

EST/ProcurementSCEM/ProductionGoods

EST/ProcurementSCEM/ProductionGoods/Feedstocks

EST/ProcurementSCEM/ProductionGoods/Utilities

EST/ProcurementSCEM/ProductionGoodsNendors

EST/ProcurementSCEM/Supplier Audits

EST/ProcurementSCEM/SupplierCertification

EST/ProcurementSCEM/SupplierCertification

EST/ProcurementSCEM/SupplierCollaboration

EST/RiskManagement

EST/RiskManagement/ELA/OperationsLiability

EST/RiskManagement/ELA/ProductLiability

EST/RiskManagement/ELA/RealEstateLiability

EST/RiskManagement/EnvironmentalLiabilityAssessment

EST/RiskManagement/ScenarioAnalysis

EST/RiskManagement/ScenarioAnalysis/EnergyPriceVolatility

EST/RiskManagement/ScenarioAnalysis/NaturalDisaters

EST/RO

EST/RO/CostAccounting

EST/RO/CostAccounting/ActivityBasedCosting

EST/RO/EnergyManagement

EST/RO/EnergyMarketAnalysis

EST/RO/EnergyMarketAnalysis/Global

EST/RO/EnergyMarketAnalysis/National

EST/RO/EnergyMarketAnalysis/Regional

EST/RO/EnergySystems

EST/RO/EnergySystems/DistributedGeneration

EST/RO/EnergySystems/ElectricSystemReliability

EST/RO/EnergySystems/ElectricSystemReliability/PowerQuality

EST/RO/EnergySystems/EnergylnformationSystems

EST/RO/EnergySystems/EnergylnformationSystems/Benefits

EST/RO/EnergySystems/EnergylnformationSystems/Strategies

EST/RO/EnergySystems/EnergylnformationSystems/Suppliers

EST/RO/EnergySystems/EnergyManagementSystems

EST/RO/EnergySystems/EnergyManagementSystems/DDC

EST/RO/EnergySystems/EnergyManagementSystems/Scheduling

EST/RO/EnergySystems/EnergyManagementSystems/SetPoint

EST/RO/EnergySystems/EnergyMetering

EST/RO/EnergySystems/EnergyMetering/SubMeteringSystems

EST/RO/EnergySystems/EnergyProcurement

EST/RO/EnergySystems/EnergyProcurement/BillAuditing

EST/RO/EnergySystems/EnergyProcurement/GreenEnergyproviders

EST/RO/EnergySystems/EnergyProcurement/LoadAggregation

EST/RO/EnergySystems/EnergyProcurement/LoadManagement

EST/RO/EnergySystems/EnergyProcurement/LoadShedding

EST/RO/EnergySystems/EnergyProcurement/LoadShifting

EST/RO/EnergySystems/EnergyProcurement/Prices

EST/RO/EnergySystems/EnergyProcurement/RateComparison

EST/RO/EnergySystems/GHGManagement

EST/RO/EnergySystems/GHGManagement/CarbonManagement

EST/RO/EnergySystems/GHGManagement/CarbonTrading

EST/RO/EquipmentReuse

EST/RO/LandManagement

EST/RO/LandManagement/Brownfield

EST/RO/MaterialsManagement

EST/RO/MaterialsManagement/Byproductreuse

EST/RO/MaterialsManagement/Recycling

EST/RO/MaterialsManagement/Recycling/CollectionSystems

EST/RO/MaterialsManagement/Recycling/ReprocessingEquipment

EST/RO/MaterialsManagement/SourceReduction

EST/RO/MaterialsManagement/WasteExchanges

EST/RO/MaterialsManagement/WasteMinimization

EST/RO/MaterialsTracking

EST/RO/PM

EST/RO/PM/PerformanceBenchmarking

EST/RO/PM/PerformanceBenchrnarking/CompanyStandards

EST/RO/PM/PerformanceBenchmarking/FacilityStandards

EST/RO/PM/PerformanceBenchmarking/IndustryStandards

EST/RO/ProcessModeling

EST/RO/WasteManagement

EST/RO/WasteManagement/WasteExchanges

EST/RO/WasteManagement/WasteTracking

EST/RO/WaterManagement

ISS

ISS/Acidification

ISS/Benchmarking

ISS/ChildLabor

ISS/EnvironmentalIndicators

ISS/EqualOpportunityEmployment

ISS/Eutrophication

ISS/FinancialIndicators

ISS/ForcedLabor

ISS/GlobalSustainability

ISS/GreenhouseGases

ISS/GroundWaterPollution

ISS/HumanRights

ISS/IndustrialEcology

ISS/LandUseDisruption

ISS/LifeCycleAssessment

ISS/LocalAirPollution

ISS/OzoneDepletion

ISS/PrisonLabor

ISS/SoilContamination

ISS/SolidWaste

ISS/SurfaceWaterPollution

ISS/SustainableAgricultureForestry

ISS/Toxicsreduction

PRO

PRO/Disposal

PRO/Disposal/Incineration

PRO/Disposal/Recycle

PRO/Disposal/Recycle/Offsite

PRO/Disposal/Recycle/Onsite

PRO/Disposal/SludgeTreatment

PRO/DisposaVWaste

PRO/Disposal/Waste/Offsite

PRO/DisposaVWaste/Onsite

PRO/DisposaUWaste/UndergroundInjection

PRO/Distribution

PRO/Distribution/Receiving

PRO/Distribution/Receiving/SecondaryPackaging

PRO/Distribution/Shipping

PRO/Distribution/Shipping/SecondaryPackaging

PRO/Distribution/Shipping/TransportModes

PRO/Distribution/Warehousing

PRO/Extraction

PRO/Extraction/Mining

PRO/Extraction/Mining/Beneficiation

PRO/Extraction/Mining/Excavation

PRO/Extraction/Mining/Exploration

PRO/Extraction/PrimaryProcessing

PRO/Extraction/PrimaryProcessing/Chemical

PRO/Extraction/PrimaryProcessing/DustRemoval

PRO/Extraction/PrimaryProcessing/Electrochemical

PRO/Extraction/PrimaryProcessing/Thermal

PRO/Manufacturing

PRO/Manufacturing/Assembly

PRO/Manufacturing/Chemical

PRO/Manufacturing/Chemical/GasPurification

PRO/Manufacturing/Electrochemical

PRO/Manufacturing/IST

PRO/Manufacturing/IST/Agriculture

PRO/Manufacturing/IST/Aluminum

PRO/Manufacturing/IST/Chemical

PRO/Manufacturing/IST/ForestProducts

PRO/Manufacturing/IST/Glass

PRO/Manufacturing/IST/InformationTechnology

PRO/Manufacturing/IST/InformationTechnology/Cleanrooms

PRO/Manufacturing/IST/InfornationTechnology/DataCenters

PRO/Manufacturing/IST/MetalCasting

PRO/Manufacturing/IST/Mining

PRO/Manufacturing/IST/Petroleum

PRO/Manufacturing/IST/Steel

PRO/Manufacturing/Machining

PRO/Manufacturing/Thermal

PRO/Manufacturing/Thermal/Combustion

PRO/OS

PRO/OS/Facility

PRO/OS/Facility/BuildingEnvelope

PRO/OS/Facility/BuildingEnvelope/AltBuildingMaterials

PRO/OS/Facility/BuildingEnvelope/Ceiling/Roof

PRO/OS/Facility/BuildingEnvelope/Foundation/Slab

PRO/OS/Facility/BuildingEnvelope/IAQ

PRO/OS/Facility/BuildingEnvelope/Insulation

PRO/OS/Facility/BuildingEnvelope/MoistureControl

PRO/OS/Facility/BuildingEnvelope/ThermalMass

PRO/OS/Facility/BuildingEnvelope/Walls

PRO/OS/Facility/BuildingEnvelope/Windows

PRO/OS/Facility/BuildingEnvelope/Windows/SmartWindows

PRO/OS/Facility/BuildingEnvelope/Windows/WindowCoatings

PRO/OS/Facility/Energy

PRO/OS/Facility/Energy/EU

PRO/OS/Facility/Energy/EU/Boilers

PRO/OS/Facility/Energy/EU/BT

PRO/OS/Facility/Energy/EU/BT/FacHVAC

PRO/OS/Facility/Energy/EU/BT/FacHVAC/Chillers

PRO/OS/Facility/Energy/EU/BT/FacHVAC/ComHVAC

PRO/OS/Facility/Energy/EU/BT/FacHVAC/ComHVAC/AirExchangeSystems

PRO/OS/Facility/Energy/EU/BT/FacHVAC/ComHVAC/HeatPumps

PRO/OS/Facility/Energy/EU/BT/FacHVAC/ComHVAC/LoopBasedHVAC

PRO/OS/Facility/Energy/EU/BT/FacHVAC/Controls

PRO/OS/Facility/Energy/EU/BT/FacHVAC/Controls/DDC

PRO/OS/Facility/Energy/EU/BT/FacHVAC/Controls/Economizers

PRO/OS/Facility/Energy/EU/BT/FacHVAC/Controls/Thermostats

PRO/OS/Facility/Energy/EU/BT/FacHVAC/Cooling

PRO/OS/Facility/Energy/EU/BT/FacHVAC/Cooling/CentralizedCooling

PRO/OS/Facility/Energy/EU/BT/FacHVAC/Cooling/SpaceCooling

PRO/OS/Facility/Energy/EU/BT/FacHVAC/DeHumidifiers

PRO/OS/Facility/Energy/EU/BT/FacHVAC/District/CentralHeatCool

PRO/OS/Facility/Energy/EU/BT/FacHVAC/HeatExchange

PRO/OS/Facility/Energy/EU/BT/FacHVAC/Heating

PRO/OS/Facility/Energy/EU/BT/FacHVAC/Heating/CentralizedHeating

PRO/OS/Facility/Energy/EU/BT/FacHVAC/Heating/SpaceHeating

PRO/OS/Facility/Energy/EU/BT/FacHVAC/ThermalStorage

PRO/OS/Facility/Energy/EU/BT/FacHVAC/Ventilation

PRO/OS/Facility/Energy/EU/BT/FacHVAC/Ventilation/FansandBlowers

PRO/OS/Facility/Energy/EU/BT/FacLighting

PRO/OS/Facility/Energy/EU/BT/FacLighting/AdvancedLightingTech

PRO/OS/Facility/Energy/EU/BT/FacLighting/ALT/CompactFluorescent

PRO/OS/Facility/Energy/EU/BT/FacLighting/ALT/DimmingControls

PRO/OS/Facility/Energy/EU/BT/FacLighting/ALT/FiberOptics

PRO/OS/Facility/Energy/EU/BT/FacLighting/ALT/FluorescentBallasts

PRO/OS/Facility/Energy/EU/BT/FacLighting/ALT/FullFluorescentLamp

PRO/OS/Facility/Energy/EU/BT/FacLighting/ALT/HighlntensityLamp

PRO/OS/Facility/Energy/EU/BT/FacLighting/ALT/LEDs

PRO/OS/Facility/Energy/EU/BT/FacLighting/ALT/PowerReducers

PRO/OS/Facility/Energy/EU/BT/FacLighting/ALT/Reflectors

PRO/OS/Facility/Energy/EU/BT/FacLighting/ALT/RemoteSourceLighting

PRO/OS/Facility/Energy/EU/BT/FacLighting/ALT/Sensors

PRO/OS/Facility/Energy/EU/BT/FacLighting/ALT/SensorsTimers

PRO/OS/Facility/Energy/EU/BT/FacLighting/ALT/SulfurLamps

PRO/OS/Facility/Energy/EU/BT/FacLighting/ALT/TaskLighting

PRO/OS/Facility/Energy/EU/BT/FacLighting/ALT/UpgradeLuminaries

PRO/OS/Facility/Energy/EU/BT/FacLighting/Daylighting

PRO/OS/Facility/Energy/EU/CAS

PRO/OS/Facility/Energy/EU/CAS/LeakControl

PRO/OS/Facility/Energy/EU/CAS/VariableSpeedDrives

PRO/OS/Facility/Energy/EU/MD

PRO/OS/Facility/Energy/EU/MD/ACInductionMotors

PRO/OS/Facility/Energy/EU/MD/AdjustedSpeedDrives

PRO/OS/Facility/Energy/EU/MD/ElectricMotors

PRO/OS/Facility/Energy/EU/MD/ElectricMotors/MotorMaintenance

PRO/OS/Facility/Energy/EU/MD/ElectricMotors/MotorSizing

PRO/OS/Facility/Energy/EU/MD/FansandBlowers

PRO/OS/Facility/Energy/EU/MD/PowerFactorControllers

PRO/OS/Facility/Energy/EU/MD/Pumps

PRO/OS/Facility/Energy/EU/MD/SuperconductingMotors

PRO/OS/Facility/Energy/EU/PlugLoads

PRO/OS/Facility/Energy/EU/PlugLoads/ITEquipment

PRO/OS/Facility/Energy/EU/PlugLoads/MediaEquipment

PRO/OS/Facility/Energy/EU/PlugLoads/MediaEquipment

PRO/OS/Facility/Energy/EU/PlugLoads/OE/Computers

PRO/OS/Facility/Energy/EU/PlugLoads/OE/Copiers

PRO/OS/Facility/Energy/EU/PlugLoads/OE/Fax

PRO/OS/Facility/Energy/EU/PlugLoads/OE/Monitors

PRO/OS/Facility/Energy/EU/PlugLoads/OE/Printers

PRO/OS/Facility/Energy/EU/PlugLoads/OE/Scanners

PRO/OS/Facility/Energy/EU/PlugLoads/OE/SmartPowerStrips

PRO/OS/Facility/Energy/EU/PlugLoads/OE/SPS/PowerManagement

PRO/OS/Facility/Energy/EU/PlugLoads/OfficeEquipment

PRO/OS/Facility/Energy/EU/PlugLoads/TaskLights

PRO/OS/Facility/Energy/EU/ProcessCooling

PRO/OS/Facility/Energy/EU/ProcessHeat

PRO/OS/Facility/Energy/EU/ProcessHeat/Drying

PRO/OS/Facility/Energy/EU/ProcessHeat/Drying

PRO/OS/Facility/Energy/EU/ProcessHeat/FansandBlowers

PRO/OS/Facility/Energy/EU/ProcessHeat/Furnaces

PRO/OS/Facility/Energy/EU/ProcessHeat/HeatExchanges

PRO/OS/Facility/Energy/EU/ProcessHeat/HeatPumps

PRO/OS/Facility/Energy/EU/ProcessHeat/WasteHeatRecovery

PRO/OS/Facility/Energy/EU/ProcessHeat/WasteHeatRecovery

PRO/OS/Facility/Energy/EU/Refrigeration/Freezers

PRO/OS/Facility/Energy/EU/Refrigeration/Freezers/Controllers

PRO/OS/Facility/Energy/EU/Refrigeration/Freezers/IceMakers

PRO/OS/Facility/Energy/EU/SensorsandControls

PRO/OS/Facility/Energy/EU/Washers

PRO/OS/Facility/Energy/EU/WaterHeating

PRO/OS/Facility/Energy/EU/WaterHeating/ElectricTank

PRO/OS/Facility/Energy/EU/WaterHeating/GasTank

PRO/OS/Facility/Energy/EU/WaterHeating/HeatPump

PRO/OS/Facility/Energy/EU/WaterHeating/TanklessWaterHeaters

PRO/OS/Facility/Energy/Generation

PRO/OS/Facility/Energy/Generation/AlternativeEnergy

PRO/OS/Facility/Energy/Generation/Cogen

PRO/OS/Facility/Energy/Generation/Cogen/CentralPlantHeatCool

PRO/OS/Facility/Energy/Generation/Cogen/CombinedHeatPower

PRO/OS/Facility/Energy/Generation/Cogen/DieselGenSets

PRO/OS/Facility/Energy/Generation/Cogen/EnergyRecovery

PRO/OS/Facility/Energy/Generation/Cogen/Turbines

PRO/OS/Facility/Energy/Generation/Cogen/Turbines/CombinedCycle

PRO/OS/Facility/Energy/Generation/EnergyConversion

PRO/OS/Facility/Energy/Generation/FuelCells

PRO/OS/Facility/Energy/Generation/SS

PRO/OS/Facility/Energy/Generation/SS/CondensateReturn

PRO/OS/Facility/Energy/Generation/SS/EnergyRecovery

PRO/OS/Facility/Energy/Generation/SS/Insulation

PRO/OS/Facility/Energy/Generation/SS/LeakControl

PRO/OS/Facility/Energy/Generation/SS/SteamTraps

PRO/OS/Facility/Energy/TD

PRO/OS/Facility/Energy/TD/LoadManagement

PRO/OS/Facility/Energy/TD/PowerQuality

PRO/OS/Facility/Energy/TD/Transformers

PRO/OS/Facility/EquipmentCleaning

PRO/OS/Facility/Landscaping

PRO/OS/Facility/Plumbing

PRO/OS/Facility/Plumbing/LeakDetection

PRO/OS/Facility/Plumbing/StorageLeaks

PRO/OS/Facility/PollutionAbatement

PRO/OS/Facility/PollutionAbatement/Scrubber

PRO/OS/Facility/Transport

PRO/OS/Facility/Transport/AirTravel

PRO/OS/Facility/Transport/TMR/AdvancedPlanningandLogistics

PRO/OS/Facility/Transport/TMR/EmployeeCommuting

PRO/OS/Facility/Transport/TMR/Telecommuting

PRO/OS/Facility/Transport/TravelMilesReduction

PRO/OS/Facility/Transport/VehicleFleet

PRO/OS/Facility/Transport/VF/AlternativeFuels

PRO/OS/Facility/Transport/VF/AlternativeVehicles

PRO/OS/Facility/Transport/VF/ImprovedPetrolFuels

PRO/OS/Facility/Transport/VF/ImprovedPetrolVehicles

PRO/OS/Failityc/Energy/EU/BT/FacLighting/ALT/ExitSigns

PRO/ProductUse

PRO/ProductUse/ProductDisposition

PRO/ProductUse/ProductLife

PRO/Suppliers

RES

RES/Air

RES/Air/CriteriaPollutants*

RES/Air/GHG*

RES/Air/HazardousAirPollutants*

RES/Air/VOCs

RES/Energy

RES/Energy/Electricity

RES/Energy/Electricity/SelfGeneratedNonrenewable

RES/Energy/Electricity/SelfGeneratedRenewable

RES/Energy/Electricity/SelfGeneratedRenewable/Solar

RES/Energy/Electricity/SelfGeneratedRenewable/Wind

RES/Energy/Electricity/SelfGeneratedRenewable/WoodBiomass

RES/Energy/Electricity/UtilityNonrenewable

RES/Energy/Electricity/UtilityRenewable

RES/Energy/Fuel

RES/Energy/Fuel/Biofuels

RES/Energy/Fuel/Coal

RES/Energy/Fuel/DieselFuel

RES/Energy/Fuel/DistillateFuelOil

RES/Energy/Fuel/Gasoline

RES/Energy/Fuel/Hydrogen

RES/Energy/Fuel/LandfillGas

RES/Energy/Fuel/LPGPropane

RES/Energy/Fuel/NaturalGas

RES/Energy/Fuel/ResidualFuelOil

RES/Financial

RES/Financial/Accounts Payable

RES/Financial/Assets

RES/Financial/Budget/Capital

RES/Financial/Budget/Operating

RES/Financial/Depreciation

RES/Financial/Issued Stock

RES/Financial/RDlnvestment

RES/Financial/Revenues

RES/Financial/Taxes

RES/Labor

RES/Labor/Labor Conditions

RES/Labor/Contract

RES/Labor/Contract/Benefits

RES/Labor/Contract/Fees

RES/Labor/LaborConditions

RES/Labor/LaborConditions/EqualOpportunityEmployment

RES/Labor/Permanent

RES/Labor/Permanent/Benefits

RES/Labor/Permanent/EmploymentStatistics

RES/Labor/Permanent/Wages

RES/Land

RES/Land/Buildings

RES/Land/Buildings/Distribution

RES/Land/Buildings/Office

RES/Land/Buildings/Retail

RES/Land/Grounds

RES/Land/Grounds/Commercial

RES/Land/Grounds/ContaminatedSites

RES/Land/Grounds/Industrial

RES/Material

RES/Material/Biobased

RES/Material/Ceramics*

RES/Material/ChemicalProperties

RES/Material/Chemicals

RES/Material/Chemicals/Lubricants*

RES/Material/Chemicals/Solvents*

RES/Material/ComponentParts

RES/Material/Composites/Specialty*

RES/Material/FinishedGoods

RES/Material/ForestProducts

RES/Material/ForestProducts/Packaging

RES/Material/ForestProducts/Paper

RES/Material/ForestProducts/Wood

RES/Material/Metals

RES/Material/Metals/Ferrous

RES/Material/Metals/Nonferrous

RES/Material/Minerals

RES/Material/PhysicalProperties

RES/Material/Polymers

RES/Material/Secondary

RES/Material/Secondary/Ceramics

RES/Material/Secondary/Chemicals

RES/Material/Secondary/ForestProducts

RES/Material/Secondary/Metals

RES/Material/Secondary/Minerals

RES/Material/Secondary/Polymers

RES/ProductsServices

RES/ProductsServices/ProductCharacteristics

RES/ProductsServices/ProductDistribution

RES/ProductsServices/Sales

RES/Waste

RES/Waste/Hazardous

RES/Waste/Hazardous/Heavymetals

RES/Waste/Hazardous/Organics

RES/Waste/Nonhazardous

RES/Waste/Sludge

RES/Water

RES/Water/Effluent

RES/Water/Effluent/Conventional

RES/Water/Effluent/NonConventional

RES/Water/Effluent/Toxic

RES/Water/Usage

RES/Water/Usage/SurfaceWater

RES/Water/Usage/Utility

GEO/Afghanistan

GEO/Albania

GEO/Algeria

GEO/Andorra

GEO/Angola

GEO/AntiguaandBarbuda

GEO/Argentina

GEO/Armenia

GEO/Australia

GEO/Austria

GEO/Azerbaijan

GEO/Bahamas

GEO/Bahrain

GEO/Bangladesh

GEO/Barbados

GEO/Belarus

GEO/Belgium

GEO/Belize

GEO/Benin

GEO/Bhutan

GEO/Bolivia

GEO/BosniaandHerzegovina

GEO/Botswana

GEO/Brazil

GEO/Brunei

GEO/Bulgaria

GEO/BurkinaFaso

GEO/Burundi

GEO/Cambodia

GEO/Cameroon

GEO/Canada

GEO/CapeVerde

GEO/CentralAfricanRepublic

GEO/Chad

GEO/Chile

GEO/China

GEO/Colombia

GEO/Comoros

GEO/Congo,DemocraticRepublicofthe

GEO/CongoBrazzaville

GEO/CostaRica

GEO/CotedIvoire

GEO/Croatia

GEO/Cuba

GEO/Cyprus

GEO/CzechRepublic

GEO/Denmark

GEO/Djibouti

GEO/Dominica

GEO/DominicanRepublic

GEO/Ecuador

GEO/Egypt

GEO/ElSalvador

GEO/EquatorialGuinea

GEO/Eritrea

GEO/Estonia

GEO/Ethiopia

GEO/Fiji

GEO/Finland

GEO/France

GEO/Gabon

GEO/Gambia

GEO/Georgia

GEO/Germany

GEO/Ghana

GEO/Greece

GEO/Grenada

GEO/Guatemala

GEO/Guinea

GEO/GuineaBissau

GEO/Guyana

GEO/Haiti

GEO/Honduras

GEO/Hungary

GEO/Iceland

GEO/India

GEO/Indonesia

GEO/Iran

GEO/Iraq

GEO/Ireland

GEO/Israel

GEO/Italy

GEO/Jamaica

GEO/Japan

GEO/Jordan

GEO/Kazakhstan

GEO/Kenya

GEO/Kiribati

GEO/Korea,North

GEO/Korea,South

GEO/Kuwait

GEO/Kyrgyzstan

GEO/Laos

GEO/Latvia

GEO/Lebanon

GEO/Lesotho

GEO/Liberia

GEO/Libya

GEO/Liechtenstein

GEO/Lithuania

GEO/Luxembourg

GEO/Macedonia

GEO/Madagascar

GEO/Malawi

GEO/Malaysia

GEO/Maldives

GEO/Mali

GEO/Malta

GEO/MarshallIslands

GEO/Mauritania

GEO/Mauritius

GEO/Mexico

GEO/Micronesia,FederatedStatesof

GEO/Moldova

GEO/Monaco

GEO/Mongolia

GEO/Morocco

GEO/Mozambique

GEO/Myanmar

GEO/Namibia

GEO/Nauru

GEO/Nepal

GEO/Netherlands

GEO/NewZealand

GEO/Nicaragua

GEO/Niger

GEO/Nigeria

GEO/Norway

GEO/Oman

GEO/Pakistan

GEO/Palau

GEO/Panama

GEO/PapuaNewGuinea

GEO/Paraguay

GEO/Peru

GEO/Philippines

GEO/Poland

GEO/Portugal

GEO/Qatar

GEO/Romania

GEO/Russia

GEO/Rwanda

GEO/SaintKittsandNevis

GEO/SaintLucia

GEO/SaintVincentandTheGrenadines

GEO/Samoa

GEO/SanMarino

GEO/SaoTomeandPrincipe

GEO/SaudiArabia

GEO/Senegal

GEO/Seychelles

GEO/SierraLeone

GEO/Singapore

GEO/Slovakia

GEO/Slovenia

GEO/SolomonIslands

GEO/Somalia

GEO/SouthAfrica

GEO/Spain

GEO/SriLanka

GEO/Sudan

GEO/Suriname

GEO/Swaziland

GEO/Sweden

GEO/Switzerland

GEO/Syria

GEO/Taiwan

GEO/Tajikistan

GEO/Tanzania

GEO/Thailand

GEO/Togo

GEO/Tonga

GEO/TrinidadandTobago

GEO/Tunisia

GEO/Turkey

GEO/Turkmenistan

GEO/Tuvalu

GEO/Uganda

GEO/Ukraine

GEO/UnitedArabEmirates

GEO/UnitedKingdom

GEO/UnitedStates

GEO/Uruguay

GEO/US

GEO/US/Alabama

GEO/US/Alaska

GEO/US/American Samoa

GEO/US/Arizona

GEO/IUS/Arkansas

GEO/US/California

GEO/US/Colorado

GEO/US/Connecticut

GEO/US/Delaware

GEO/US/District of Columbia

GEO/US/Florida

GEO/US/Georgia

GEO/US/Guam

GEO/US/Hawaii

GEO/US/Idaho

GEO/US/Illinois

GEOJUS/Indiana

GEO/US/Iowa

GEO/US/Kansas

GEO/US/Kentucky

GEO/US/Louisiana

GEO/US/Maine

GEO/US/Maryland

GEO/US/Massachusetts

GEO/US/Michigan

GEO/US/Minnesota

GEO/US/Mississippi

GEO/US/Missouri

GEO/US/Montana

GEO/US/Nebraska

GEO/US/Nevada

GEO/US/NewHampshire

GEO/US/NewJersey

GEO/US/NewMexico

GEO/US/NewYork

GEO/US/NorthCarolina

GEO/US/NorthDakota

GEO/US/Northern Mariana Islands

GEO/US/Ohio

GEO/US/Oklahoma

GEO/US/Oregon

GEO/US/Pennsylvania

GEO/US/Puerto Rico

GEO/US/RhodeIsland

GEO/US/SouthCarolina

GEO/US/SouthDakota

GEO/US/Tennessee

GEO/US/Texas

GEO/US/US Virgin Islands

GEO/US/Utah

GEO/US/Vermont

GEO/US/Virginia

GEO/US/Washington

GEO/US/WestVirginia

GEO/US/Wisconsin

GEO/US/Wyoming

GEO/Uzbekistan

GEO/Vanuatu

GEO/VaticanCity

GEO/Venezuela

GEO/Vietnam

GEO/WesternSahara

GEO/Yemen

GEO/YugoslaviaSerbiaandMontenegro

GEO/Zambia

GEO/Zimbabwe

GEO/Zimbabwe

IND/Agriculture, Forestry, Fishing and Hunting11

IND/Crop Production111

IND/Oilseed and Grain Farming1111

IND/Vegetable and Melon Farming1112

IND/Fruit and Tree Nut Farming1113

IND/Greenhouse, Nursery, and Floriculture Production1114

IND/Other Crop Farming1119

IND/Animal Production112

IND/Cattle Ranching and Farming1121

IND/Hog and Pig Farming1122

IND/Poultry and Egg Production1123

IND/Sheep and Goat Farming1124

IND/Animal Aquaculture1125

IND/Other Animal Production1129

IND/Forestry and Logging113

IND/Timber Tract Operations1131

IND/Forest Nurseries and Gathering of Forest Products1132

IND/Logging1133

IND/Fishing, Hunting and Trapping114

IND/Fishing1141

IND/Hunting and Trapping1142

IND/Support Activities for Agriculture and Forestry115

IND/Support Activities for Crop Production1151

IND/Support Activities for Animal Production1152

IND/Support Activities for Forestry1153

IND/Mining21

IND/Oil and Gas Extraction211

IND/Oil and Gas Extraction2111

IND/Mining (except Oil and Gas)212

IND/Coal Mining2121

IND/Metal Ore Mining2122

IND/Nonmetallic Mineral Mining and Quarrying2123

IND/Support Activities for Mining213

IND/Support Activities for Mining2131

IND/Utilities22

IND/Utilities221

IND/Electric Power Generation, Transmission and Distribution2211

IND/Natural Gas Distribution2212

IND/Water, Sewage and Other Systems2213

IND/Construction23

IND/Building, Developing, and General Contracting233

IND/Land Subdivision and Land Development2331

IND/Residential Building Construction2332

IND/Nonresidential Building Construction2333

IND/Heavy Construction234

IND/Highway, Street, Bridge, and Tunnel Construction2341

IND/Other Heavy Construction2349

IND/Special Trade Contractors235

IND/Plumbing, Heating, and Air-Conditioning Contractors2351

IND/Painting and Wall Covering Contractors2352

IND/Electrical Contractors2353

IND/Masonry, Drywall, Insulation, and Tile Contractors2354

IND/Carpentry and Floor Contractors2355

IND/Roofing, Siding, and Sheet Metal Contractors2356

IND/Concrete Contractors2357

IND/Water Well Drilling Contractors2358

IND/Other Special Trade Contractors2359

IND/Food Manufacturing311

IND/Animal Food Manufacturing3111

IND/Grain and Oilseed Milling3112

IND/Sugar and Confectionery Product Manufacturing3113

IND/Fruit and Vegetable Preserving and Specialty Food Manufacturing3114

IND/Dairy Product Manufacturing3115

IND/Animal Slaughtering and Processing3116

IND/Seafood Product Preparation and Packaging3117

IND/Bakeries and Tortilla Manufacturing3118

IND/Other Food Manufacturing3119

IND/Beverage and Tobacco Product Manufacturing312

IND/Beverage Manufacturing3121

IND/Tobacco Manufacturing3122

IND/Textile Mills313

IND/Fiber, Yarn, and Thread Mills3131

IND/Fabric Mills3132

IND/Textile and Fabric Finishing and Fabric Coating Mills3133

IND/31-33 Manufacturing

IND/Textile Product Mills314

IND/Textile Furnishings Mills3141

IND/Other Textile Product Mills3149

IND/Apparel Manufacturing315

IND/Apparel Knitting Mills3151

IND/Cut and Sew Apparel Manufacturing3152

IND/Apparel Accessories and Other Apparel Manufacturing3159

IND/Leather and Allied Product Manufacturing316

IND/Leather and Hide Tanning and Finishing3161

IND/Footwear Manufacturing3162

IND/Other Leather and Allied Product Manufacturing3169

IND/Wood Product Manufacturing321

IND/Sawmills and Wood Preservation3211

IND/Veneer, Plywood, and Engineered Wood Product Manufacturing3212

IND/Other Wood Product Manufacturing3219

IND/Paper Manufacturing322

IND/Pulp, Paper, and Paperboard Mills3221

IND/Converted Paper Product Manufacturing3222

IND/Printing and Related Support Activities323

IND/Printing and Related Support Activities3231

IND/Petroleum and Coal Products Manufacturing324

IND/Petroleum and Coal Products Manufacturing3241

IND/Chemical Manufacturing325

IND/Basic Chemical Manufacturing3251

IND/Resin, Synthetic Rubber, and Artificial and Synthetic Fibers and Filaments Manufacturing3252

IND/Pesticide, Fertilizer, and Other Agricultural Chemical Manufacturing3253

IND/Pharmaceutical and Medicine Manufacturing3254

IND/Paint, Coating, and Adhesive Manufacturing3255

IND/Soap, Cleaning Compound, and Toilet Preparation Manufacturing3256

IND/Other Chemical Product and Preparation Manufacturing3259

IND/Plastics and Rubber Products Manufacturing326

IND/Plastics Product Manufacturing3261

IND/Rubber Product Manufacturing3262

IND/Nonmetallic Mineral Product Manufacturing327

IND/Clay Product and Refractory Manufacturing3271

IND/Glass and Glass Product Manufacturing3272

IND/Cement and Concrete Product Manufacturing3273

IND/Lime and Gypsum Product Manufacturing3274

IND/Other Nonmetallic Mineral Product Manufacturing3279

IND/Primary Metal Manufacturing331

IND/Iron and Steel Mills and Ferroalloy Manufacturing3311

IND/Steel Product Manufacturing from Purchased Steel3312

IND/Alumina and Aluminum Production and Processing3313

IND/Nonferrous Metal (except Aluminum) Production and Processing3314

IND/Foundries3315

IND/Fabricated Metal Product Manufacturing332

IND/Forging and Stamping3321

IND/Cutlery and Handtool Manufacturing3322

IND/Architectural and Structural Metals Manufacturing3323

IND/Boiler, Tank, and Shipping Container Manufacturing3324

IND/Hardware Manufacturing3325

IND/Spring and Wire Product Manufacturing3326

IND/Machine Shops; Turned Product; and Screw, Nut, and Bolt Manufacturing3327

IND/Coating, Engraving, Heat Treating, and Allied Activities3328

IND/Other Fabricated Metal Product Manufacturing3329

IND/Machinery Manufacturing333

IND/Agriculture, Construction, and Mining Machinery Manufacturing3331

IND/Industrial Machinery Manufacturing3332

IND/Commercial and Service Industry Machinery Manufacturing3333

INDNentilation, Heating, Air-Conditioning, and Commercial Refrigeration Equipment Manufacturing3334

IND/Metalworking Machinery Manufacturing3335

IND/Engine, Turbine, and Power Transmission Equipment Manufacturing3336

IND/Other General Purpose Machinery Manufacturing3339

IND/Computer and Electronic Product Manufacturing334

IND/Computer and Peripheral Equipment Manufacturing3341

IND/Communications Equipment Manufacturing3342

IND/Audio and Video Equipment Manufacturing3343

IND/Semiconductor and Other Electronic Component Manufacturing3344

IND/Navigational, Measuring, Electromedical, and Control Instruments Manufacturing3345

IND/Manufacturing and Reproducing Magnetic and Optical Media3346

IND/Electrical Equipment, Appliance, and Component Manufacturing335

IND/Electric Lighting Equipment Manufacturing3351

IND/Household Appliance Manufacturing3352

IND/Electrical Equipment Manufacturing3353

IND/Other Electrical Equipment and Component Manufacturing3359

IND/Transportation Equipment Manufacturing336

IND/Motor Vehicle Manufacturing3361

IND/Motor Vehicle Body and Trailer Manufacturing3362

IND/Motor Vehicle Parts Manufacturing3363

IND/Aerospace Product and Parts Manufacturing3364

IND/Railroad Rolling Stock Manufacturing3365

IND/Ship and Boat Building3366

IND/Other Transportation Equipment Manufacturing3369

IND/Furniture and Related Product Manufacturing337

IND/Household and Institutional Furniture and Kitchen Cabinet Manufacturing3371

IND/Office Furniture (including Fixtures) Manufacturing3372

IND/Other Furniture Related Product Manufacturing3379

IND/Miscellaneous Manufacturing339

IND/Medical Equipment and Supplies Manufacturing3391

IND/Other Miscellaneous Manufacturing3399

IND/Wholesale Trade42

IND/Wholesale Trade, Durable Goods421

IND/Motor Vehicle and Motor Vehicle Parts and Supplies Wholesalers4211

IND/Furniture and Home Furnishing Wholesalers4212

IND/Lumber and Other Construction Materials Wholesalers4213

IND/Professional and Commercial Equipment and Supplies Wholesalers4214

IND/Metal and Mineral (except Petroleum) Wholesalers4215

IND/Electrical Goods Wholesalers4216

IND/Hardware, and Plumbing and Heating Equipment and Supplies Wholesalers4217

IND/Machinery, Equipment, and Supplies Wholesalers4218

IND/Miscellaneous Durable Goods Wholesalers4219

IND/Wholesale Trade, Nondurable Goods422

IND/Paper and Paper Product Wholesalers4221

IND/Drugs and Druggists' Sundries Wholesalers4222

IND/Apparel, Piece Goods, and Notions Wholesalers4223

IND/Grocery and Related Product Wholesalers4224

IND/Farm Product Raw Material Wholesalers4225

IND/Chemical and Allied Products Wholesalers4226

IND/Petroleum and Petroleum Products Wholesalers4227

IND/Beer, Wine, and Distilled Alcoholic Beverage Wholesalers4228

IND/Miscellaneous Nondurable Goods Wholesalers4229

IND/Motor Vehicle and Parts Dealers441

IND/Automobile Dealers4411

IND/Other Motor Vehicle Dealers4412

IND/Automotive Parts, Accessories, and Tire Stores4413

IND/Furniture and Home Furnishings Stores442

IND/Furniture Stores4421

IND/Home Furnishings Stores4422

IND/Electronics and Appliance Stores443

IND/Electronics and Appliance Stores4431

IND/Building Material and Garden Equipment and Supplies Dealers444

IND/Building Material and Supplies Dealers4441

IND/Lawn and Garden Equipment and Supplies Stores4442

IND/44-45 Retail Trade

IND/Food and Beverage Stores445

IND/Grocery Stores4451

IND/Specialty Food Stores4452

IND/Beer, Wine, and Liquor Stores4453

IND/Health and Personal Care Stores446

IND/Health and Personal Care Stores4461

IND/Gasoline Stations447

IND/Gasoline Stations4471

IND/Clothing and Clothing Accessories Stores448

IND/Clothing Stores4481

IND/Shoe Stores4482

IND/Jewelry, Luggage, and Leather Goods Stores4483

IND/Sporting Goods, Hobby, Book, and Music Stores451

IND/Sporting Goods, Hobby, and Musical Instrument Stores4511

IND/Book, Periodical, and Music Stores4512

IND/General Merchandise Stores452

IND/Department Stores4521

IND/Other General Merchandise Stores4529

IND/Miscellaneous Store Retailers453

IND/Florists4531

IND/Office Supplies, Stationery, and Gift Stores4532

IND/Used Merchandise Stores4533

IND/Other Miscellaneous Store Retailers4539

IND/Nonstore Retailers454

IND/Electronic Shopping and Mail-Order Houses4541

IND/Vending Machine Operators4542

IND/Direct Selling Establishments4543

IND/Air Transportation481

IND/Scheduled Air Transportation4811

IND/Nonscheduled Air Transportation4812

IND/Rail Transportation482

IND/Rail Transportation4821

IND/Water Transportation483

IND/Deep Sea, Coastal, and Great Lakes Water Transportation4831

IND/Inland Water Transportation4832

IND/Truck Transportation484

IND/General Freight Trucking4841

IND/Specialized Freight Trucking4842

IND/48-49 Transportation and Warehousing

IND/Transit and Ground Passenger Transportation485

IND/Urban Transit Systems4851

IND/Interurban and Rural Bus Transportation4852

IND/Taxi and Limousine Service4853

IND/School and Employee Bus Transportation4854

IND/Charter Bus Industry4855

IND/Other Transit and Ground Passenger Transportation4859

IND/Pipeline Transportation486

IND/Pipeline Transportation of Crude 0il4861

IND/Pipeline Transportation of Natural Gas4862

IND/Other Pipeline Transportation4869

IND/Scenic and Sightseeing Transportation487

IND/Scenic and Sightseeing Transportation, Land4871

IND/Scenic and Sightseeing Transportation, Water4872

IND/Scenic and Sightseeing Transportation, Other4879

IND/Support Activities for Transportation488

IND/Support Activities for Air Transportation4881

IND/Support Activities for Rail Transportation4882

IND/Support Activities for Water Transportation4883

IND/Support Activities for Road Transportation4884

IND/Freight Transportation Arrangement4885

IND/Other Support Activities for Transportation4889

IND/Postal Service491

IND/Postal Service4911

IND/Couriers and Messengers492

IND/Couriers4921

IND/Local Messengers and Local Delivery4922

IND/Warehousing and Storage493

IND/Warehousing and Storage4931

IND/Information51

IND/Publishing Industries511

IND/Newspaper, Periodical, Book, and Database Publishers5111

IND/Software Publishers5112

IND/Motion Picture and Sound Recording Industries512

IND/Motion Picture and Video Industries5121

IND/Sound Recording Industries5122

IND/Broadcasting and Telecommunications513

IND/Radio and Television Broadcasting5131

IND/Cable Networks and Program Distribution5132

IND/Telecommunications5133

IND/Information Services and Data Processing Services5l4

IND/Information Services5141

IND/Data Processing Services5l42

IND/Finance and Insurance52

IND/Monetary Authorities—Central Bank521

IND/Monetary Authorities—Central Bank5211

IND/Credit Intermediation and Related Activities522

IND/Depository Credit Intermediation5221

IND/Nondepository Credit Intermediation5222

IND/Activities Related to Credit Intermediation5223

IND/Securities, Commodity Contracts, and Other Financial Investments and Related Activities523

IND/Securities and Commodity Contracts Intermediation and Brokerage5231

IND/Securities and Commodity Exchanges5232

IND/Other Financial Investment Activities5239

IND/Insurance Carriers and Related Activities524

IND/Insurance Carriers5241

IND/Agencies, Brokerages, and Other Insurance Related Activities5242

IND/Funds, Trusts, and Other Financial Vehicles525

IND/Insurance and Employee Benefit Funds5251

IND/Other Investment Pools and Funds5259

IND/Real Estate and Rental and Leasing53

IND/Real Estate531

IND/Lessors of Real Estate5311

IND/Offices of Real Estate Agents and Brokers5312

IND/Activities Related to Real Estate5313

IND/Rental and Leasing Services532

IND/Automotive Equipment Rental and Leasing5321

IND/Consumer Goods Rental5322

IND/General Rental Centers5323

IND/Commercial and Industrial Machinery and Equipment Rental and Leasing5324

IND/Lessors of Nonfinancial Intangible Assets (except Copyrighted Works)533

IND/Lessors of Nonfinancial Intangible Assets (except Copyrighted Works)5331

IND/Professional, Scientific, and Technical Services54

IND/Professional, Scientific, and Technical Services541

IND/Legal Services5411

IND/Accounting, Tax Preparation, Bookkeeping, and Payroll Services5412

IND/Architectural, Engineering, and Related Services5413

IND/Specialized Design Services5414

IND/Computer Systems Design and Related Services5415

IND/Management, Scientific, and Technical Consulting Services5416

IND/Scientific Research and Development Services5417

IND/Advertising and Related Services5418

IND/Other Professional, Scientific, and Technical Services5419

IND/Management of Companies and Enterprises55

IND/Management of Companies and Enterprises551

IND/Management of Companies and Enterprises5511

IND/Administrative and Support and Waste Management and Remediation Services56

IND/Administrative and Support Services561

IND/Office Administrative Services5611

IND/Facilities Support Services5612

IND/Employment Services5613

IND/Business Support Services5614

IND/Travel Arrangement and Reservation Services5615

IND/Investigation and Security Services5616

IND/Services to Buildings and Dwellings5617

IND/Other Support Services5619

IND/Waste Management and Remediation Services562

IND/Waste Collection5621

IND/Waste Treatment and Disposal5622

IND/Remediation and Other Waste Management Services5629

IND/Educational Services61

IND/Educational Services611

IND/Elementary and Secondary Schools6111

IND/Junior Colleges6112

IND/Colleges, Universities, and Professional Schools6113

IND/Business Schools and Computer and Management Training6114

IND/Technical and Trade Schools6115

IND/Other Schools and Instruction6116

IND/Educational Support Services6117

IND/Health Care and Social Assistance62

IND/Ambulatory Health Care Services621

IND/Offices of Physicians6211

IND/Offices of Dentists6212

IND/Offices of Other Health Practitioners6213

IND/Outpatient Care Centers6214

IND/Medical and Diagnostic Laboratories6215

IND/Home Health Care Services6216

IND/Other Ambulatory Health Care Services6219

IND/Hospitals622

IND/General Medical and Surgical Hospitals6221

IND/Psychiatric and Substance Abuse Hospitals6222

IND/Specialty (except Psychiatric and Substance Abuse) Hospitals6223

IND/Nursing and Residential Care Facilities623

IND/Nursing Care Facilities6231

IND/Residential Mental Retardation, Mental Health and Substance Abuse Facilities6232

IND/Community Care Facilities for the Elderly6233

IND/Other Residential Care Facilities6239

IND/Social Assistance624

IND/Individual and Family Services6241

IND/Community Food and Housing, and Emergency and Other Relief Services6242

IND/Vocational Rehabilitation Services6243

IND/Child Day Care Services6244

IND/Arts, Entertainment, and Recreation71

IND/Performing Arts, Spectator Sports, and Related Industries711

IND/Performing Arts Companies7111

IND/Spectator Sports7112

IND/Promoters of Performing Arts, Sports, and Similar Events7113

IND/Agents and Managers for Artists, Athletes, Entertainers, and Other Public Figures7114

IND/Independent Artists, Writers, and Performers7115

IND/Museums, Historical Sites, and Similar Institutions712

IND/Museums, Historical Sites, and Similar Institutions7121

IND/Amusement, Gambling, and Recreation Industries713

IND/Amusement Parks and Arcades7131

IND/Gambling Industries7132

IND/Other Amusement and Recreation Industries7139

IND/Accommodation and Food Services72

IND/Accommodation721

IND/Traveler Accommodation7211

IND/RV (Recreational Vehicle) Parks and Recreational Camps7212

IND/Rooming and Boarding Houses7213

IND/Food Services and Drinking Places722

IND/Full-Service Restaurants7221

IND/Limited-Service Eating Places7222

IND/Special Food Services7223

IND/Drinking Places (Alcoholic Beverages)7224

IND/Other Services (except Public Administration)81

IND/Repair and Maintenance811

IND/Automotive Repair and Maintenance8111

IND/Electronic and Precision Equipment Repair and Maintenance8112

IND/Commercial and Industrial Machinery and Equipment (except Automotive and Electronic) Repair and Maintenance8113

IND/Personal and Household Goods Repair and Maintenance8114

IND/Personal and Laundry Services812

IND/Personal Care Services8121

IND/Death Care Services8122

IND/Drycleaning and Laundry Services8123

IND/Other Personal Services8129

IND/Religious, Grantmaking, Civic, Professional, and Similar Organizations813

IND/Religious Organizations8131

IND/Grantmaking and Giving Services8132

IND/Social Advocacy Organizations8133

IND/Civic and Social Organizations8134

IND/Business, Professional, Labor, Political, and Similar Organizations8139

IND/Private Households814

IND/Private Households8141

IND/Public Administration92

IND/Executive, Legislative, and Other General Government Support921

IND/Executive, Legislative, and Other General Government Support9211

IND/Justice, Public Order, and Safety Activities922

IND/Justice, Public Order, and Safety Activities9221

IND/Administration of Human Resource Programs923

IND/Administration of Human Resource Programs9231

IND/Administration of Environmental Quality Programs924

IND/Administration of Environmental Quality Programs9241

IND/Administration of Housing Programs, Urban Planning, and Community Development925

IND/Administration of Housing Programs, Urban Planning, and Community Development9251

IND/Administration of Economic Programs926

IND/Administration of Economic Programs9261

IND/Space Research and Technology927

IND/Space Research and Technology9271

IND/National Security and International Affairs928

IND/National Security and International Affairs9281

APPENDIX II
Map from User Classes to CMS DCIs

```
<?xml version=“1.0” encoding =“utf-8” ?>
<!DOCTYPE translation (View Source for full doctype...)>
-<!-
Userclass to BET mapping
-<translation>
- <userclass name= “Accounting” id=“−1”>
    <bet>RES/Financial</bet>
    <bet>RES/Financial/Revenues</bet>
    <bet>RES/Financial/BudgetCapital</bet>
    <bet>RES/Financial/Budget/Operating</bet>
    <bet>RES/Financial/AccountsPayable</bet>
    <bet>RES/Financial/Depreciation</bet>
    <bet>RES/Financial/IssuedStock</bet>
    <bet>RES/Financial/Assets</bet>
    <bet>RES/Financial/Taxes</bet>
    <bet>RES/Financial/RDInvestment</bet>
    <bet>EST/RiskManagement</bet>
    <bet>EST/RiskManagement/ELA</bet>
    <bet>EST/RiskManagement/ELA/RealEstateLiability</bet>
    <bet>EST/RiskManagement/ELA/ProductLiability</bet>
        <bet>EST/RiskManagement/ELA/OperationsLiability</bet>
</userclass>
- <userclass name= “Community Relations” id=“−1”>
        <bet>EST/CSC/CommunityRelations</bet>
        <bet>EST/CSC/CommunityRelations/Local</bet>
            <bet>EST/CSC/CommunityRelations/LocalContributions</bet>
            <bet>EST/CSC/CommunityRelations/LocalVolunteer</bet>
<bet>EST/CSC/CommunityRelations/Global</bet>
<bet>EST/CSC/CommunityRelations/Global/Contributions</bet>
        <bet>EST/CSC/CommunityRelations/Global/Volunteer</bet>
        <bet>EST/CSC/CommunityRelations/Global</bet>
        <bet>EST/CSC/CER</bet>
</userclass>
- <userclass name=“EHS (senior manager)” id=“−1”>
        <bet>EST/HS</bet>
        <bet>EST/HS/FacilitySafety</bet>
        <bet>EST/HS/FacilitySafety/Emergency Response</bet>
        <bet>EST/HS/FacilitySafety/Plans</bet>
                    <bet>EST/HS/FacilitySafety/Training</bet>
                      <bet>EST/HS/FacilitySafety/Spills</bet>
                    <bet>EST/HS/FacilitySafety/Training</bet>
<bet>EST/HS/FacilitySafety/Equipment</bet>
<bet>EST/HS/FacilitySafety/BuildingSafety</bet>
        <bet>EST/HS/FacilitySafety/BuildingSafety/FirePrevention</bet>
<bet>EST/HS/WorkerHealth</bet>
<bet>EST/HS/WorkerHealth/InjuriesLostDays</bet>
<bet>EST/HS/WorkerHealth/ProtectiveEquipment</bet>
<bet>EST/HS/WorkerHealth/IndoorAirQuality</bet>
<bet>EST/HS/WorkerHealth/AccidentPrevention</bet>
                    <bet>EST/HS/WorkerHealth/Training</bet>
                      <bet>EST/HS/WorkerHealth/MSDS</bet>
<bet>EST/HS/WorkerHealth/Ergonomics</bet>
        <bet>EST/HS/WorkerHealth/Ergonomics/RepetitiveMotion</bet>
<bet>EST/HS/WorkerHealth/Ergonomics/Lifting</bet>
<bet>EST/RO</bet>
<bet>EST/RO/EnergyManagement</bet>
<bet>EST/RO/EnergySystems</bet>
        <bet>EST/RO/EnergySystems/EnergyManagementSystems</bet>
        <bet>EST/RO/EnergySystems/EnergyManagementSystems/Scheduling</bet>
<bet>RES/Air</bet>
<bet>RES/Air/HazardousAlrPollutants</bet>
<bet>RES/Air/GHG</bet>
<bet>RES/Air/CriteriaPollutants</bet>
<bet>RES/Air/VOCs</bet>
<bet>RES/Waste</bet>
<bet>RES/Waste/Hazardous</bet>
<bet>RES/Waste/Hazardous/Organics</bet>
<bet>RES/Waste/Hazardous/Heavymetals</bet>
<bet>RES/Waste/Nonhazardous</bet>
<bet>EST/Compliance</bet>
<bet>EST/Compliance/USEPA</bet>
<bet>EST/Compliance/USDOT</bet>
<bet>EST/Compliance/OSHA/Permits</bet>
<bet>EST/Compliance/USDOL/Regulations</bet>
<bet>EST/Compliance/Intl</bet>
<bet>EST/Compliance/EU</bet>
<bet>EST/Compliance/VoluntaryStandards</bet>
        <bet>EST/Compliance/VoluntaryStandards/GHGProtocol</bet>
<bet>EST/Compliance/VoluntaryStandards/GRI</bet>
        <bet>EST/Compliance/VoluntaryStandards/ISO14032</bet>
                <bet>EST/Compliance/VoluntaryStandards/GEMI</bet>
                    <bet>EST/Compliance/USStateEPA</bet>
</userclass>
- <userclass name=“Energy-process/operations” id=“−1”>
<bet>PRO/OS/Facility/Energy</bet>
<bet>PRO/OS/Facility/Energy/Generation</bet>
<bet>PRO/OS/Facility/Energy/Generation/Cogen</bet>
        <bet>PRO/OS/Facility/Energy/Generation/Steam Systems</bet>
        <bet>PRO/OS/Facility/Energy/Generation/Alternative Energy</bet>
        <bet>PRO/OS/Facility/Energy/Generation/FuelCells</bet>
<bet>PRO/OS/Facility/Energy/TD</bet>
<bet>PRO/OS/Facility/Energy/EU</bet>
<bet>PRO/OS/Facility/Energy/EU/ProcessCooling</bet>
<bet>PRO/OS/Facility/Energy/EU/ProcessHeat</bet>
<bet>PRO/OS/Facility/Energy/EU/BT</bet>
<bet>PRO/OS/Facility/Energy/EU/BT/FacHVAC</bet>
<bet>PRO/OS/Facility/Energy/EU/BT/FacLighting</bet>
        <bet>PRO/OS/Facility/Energy/EU/BT/FacLightingALT</bet>
        <bet>PRO/OS/Facility/Energy/EU/CAS/FacLighting</bet>
<bet>PRO/OS/Facility/Energy/EU/MD</bet>
        <bet>PRO/OS/Facility/Energy/EU/WaterHeating</bet>
<bet>PRO/OS/Facility/Energy/EU/SensorsandControls</bet>
<bet>PRO/OS/Facility/Energy/EU/Boilers</bet>
<bet>PRO/OS/Facility/BuildingEnvelope</bet>
<bet>EST/RO/EnergyManagement</bet>
<bet>EST/RO/EnergySystems</bet>
<bet>EST/RO/EnergySystems/EnergyMetering</bet>
<bet>EST/RO/EnergySystems/DistributedGeneration</bet>
<bet>EST/RO/EnergySystems/GHGManagement</bet>
</userclass>
- <userclass name=“Energy-procurement” id=“−1”>
        <bet>EST/RO/EnergySystems/Energy/Metering</bet>
        <bet>EST/RO/EnergySystems/Energy/Metering/SubMeteringSystems</bet>
        <bet>EST/RO/EnergySystems/Energy/Procurement</bet>
                <bet>EST/RO/EnergySystems/Energy/Procurement/LoadManagement</bet>
        <bet>EST/RO/EnergySystems/Energy/Procurement/LoadShifting</bet>
        <bet>EST/RO/EnergySystems/Energy/Procurement/LoadShedding</bet>
        <bet>EST/RO/EnergySystems/Energy/Procurement/BillAuditing</bet>
        <bet>EST/RO/EnergySystems/Energy/Procurement/RateComparison</bet>
        <bet>EST/RO/EnergySystems/Energy/Procurement/LoadAggregation</bet>
        <bet>EST/RO/EnergySystems/Energy/Procurement/GreenEnergy/Providers</bet>
        <bet>EST/RO/EnergySystems/Energy/Procurement/BillAuditing</bet>
        <bet>EST/RO/EnergySystems/Energy/Procurement/RateComparison</bet>
</userclass>
- <userclass name=“Environmental Marcom” id=“−1”>
<bet>EST/CSC</bet>
<bet>EST/CSC/InvestorRelations</bet>
<bet>EST/CSC/CommunityRelations</bet>
<bet>EST/CSC/CommunityRelations/Local</bet>
        <bet>EST/CSC/CommunityRelations/Local/Contributions</bet>
        <bet>EST/CSC/CommunityRelations/Local /Volunteer</bet>
<bet>EST/CSC/CommunityRelations/Global</bet>
        <bet>EST/CSC/CommunityRelations/Global/Contributions</bet>
        <bet>EST/CSC/CommunityRelations/Global/Volunteer</bet>
<bet>EST/CSC/CommunityRelations/Global</bet>
<bet>EST/CSC/GovernmentRelations</bet>
<bet>EST/CSC/LaborRelations</bet>
<bet>EST/CSC/TechnologyPlanning</bet>
<bet>EST/CSC/Financial Planning</bet>
<bet>EST/CSC/CER</bet>
<bet>EST/CSC/CER/Quality</bet>
<bet>EST/CSC/CER/Financial Markets</bet>
<bet>EST/CSC/Environmental MarketOpportunities</bet>
        <bet>EST/CSC/Environmental MarketOpportunities/EmissionsMarkets</bet>
<bet>EST/PD/PS</bet>
<bet>EST/PD/PS/SalesMarketing</bet>
        <bet>EST/PD/PS/SalesMarketing /Product Differentiation</bet>
        <bet>EST/PD/PS/SalesMarketing/GreenMarketing</bet>
        <bet>EST/PD/PS/SalesMarketing/EnvironmentalCertification</bet>
        <bet>EST/PD/PS/SalesMarketing/ProductTakeback</bet>
</userclass>
- <userclass name=“Facilities Manager” id=“−1”>
<bet>PRO/Disposal</bet>
<bet>PRO/OS/Facility</bet>
<bet>PRO/OS/Facility/Energy</bet>
<bet>PRO/OS/Facility/Energy/EU</bet>
<bet>PRO/Distribution</bet>
<bet>PRO/Manufacturing/Assembly</bet>
<bet>PRO/OS/Facility/Landscaping</bet>
<bet>PRO/OS/Facility/EquipmentCleaning</bet>
<bet>PRO/OS/Facility/Plumbing</bet>
<bet>PRO/OS/Facility/Transport</bet>
</userclass>
- <userclass name=“FacilitySafety” id=“−1”>
<bet>EST/HS</bet>
<bet>EST/HS/FacilitySafety</bet>
<bet>EST/HS/FacilitySafety/EmergencyResponse</bet>
<bet>EST/HS/FacilitySafety/Plans</bet>
<bet>EST/HS/FacilitySafety/Training</bet>
<bet>EST/HS/FacilitySafetySpills</bet>
<bet>EST/HS/FacilitySafety/Training</bet>
<bet>EST/HS/FacilitySafety/SafetyEquipment</bet>
<bet>EST/HS/FacilitySafety/BuildingSafety</bet>
<bet>EST/HS/FacilitySafety/BuildingSafety/FirePrevention</bet>
<bet>EST/HS/WorkerHealth</bet>
</userclass>
- <userclass name=“Finance - capital investment” id=“−1”>
<bet>RES/Financial</bet>
<bet>RES/Financial/Revenues</bet>
<bet>RES/Financial/Budget/Capital</bet>
<bet>RES/Financial/Budget/Operating</bet>
<bet>RES/Financial/AccountsPayable</bet>
<bet>RES/Financial/Depreciation</bet>
<bet>RES/Financial/IssuedStock</bet>
<bet>RES/Financial/Assets</bet>
<bet>RES/Financial/Taxes</bet>
<bet>RES/Financial/RDInvestment</bet>
<bet>EST/CSC/CER/FinancialMarkets</bet>
<bet>EST/CSC/Environmental MarketOpportunities</bet>
        <bet>EST/CSC/Environmental MarketOpportunities/EmissionsMarkets</bet>
<bet>EST/CSC</bet>
<bet>EST/CSC/InvestorRelations</bet>
<bet>EST/CSC/Financial Planning</bet>
</userclass>
- <userclass name=“GHG” id=“−1”>
        <bet>ISS/GreenhouseGases</bet>
        <bet>EST/RO/EnergySystems/GHGManagement</bet>
        <bet>EST/RO/EnergySystems/GHGManagement/CarbonTrading</bet>
</userclass>
- <userclass name=“Hazardous Material mgt.” id=“−1”>
<bet>EST/PD/Process/ToxicReduction</bet>
<bet>EST/RO/WasteManagement</bet>
<bet>RES/Waste</bet>
<bet>EST/RO/WasteManagement/WasteTracking</bet>
<bet>EST/PP/HazardousMaterialsMinimization</bet>
        <bet>EST/PP/HazardousMaterialsMinimization/Alternativematerials</bet>
        <bet>EST/PP/HazardousMaterialsMinimization/Alternativeprocesses</bet>
<bet>PRO/Disposal/Waste</bet>
</userclass>
- <userclass name=“Information Systems” id=“−1”>
        <bet>EST/RO/EnergySystems/EnergyInformationSystems</bet>
        <bet>EST/RO/EnergySystems/EnergyInformationSystems/Benefits</bet>
        <bet>EST/RO/EnergySystems/EnergyInformationSystems/Suppliers</bet>
        <bet>EST/RO/EnergySystems/EnergyInformationSystems/Strategies</bet>
        <bet>EST/RO/WasteManagement/WasteTracking</bet>
</userclass>
- <userclass name=“Investor Relations” id=“−1”>
        <bet>EST/CSC/CER</bet>
        <bet>EST/CSC/CER/Quality</bet>
        <bet>EST/CSC/CER/Financial Markets</bet>
</userclass>
- <userclass name=“Labor Relations” id=“−1”>
<bet>RES/Labor</bet>
        <bet>RES/Labor/Permanent</bet>
        <bet>RES/Labor/Permanent/EmploymentStatistics</bet>
        <bet>RES/Labor/Permanent/Wages</bet>
        <bet>RES/Labor/Permanent/Benefits</bet>
        <bet>RES/Labor/LaborConditions</bet>
        <bet>RES/Labor/LaborConditions/EOE</bet>
        <bet>RES/Labor/Contract</bet>
        <bet>RES/Labor/Contract/Benefits</bet>
        <bet>RES/Labor/Contract/Fees</bet>
        <bet>EST/CSC/LaborRelations</bet>
        <bet>ISS/EqualOpportunityEmployment</bet>
</userclass>
- <userclass name=“Legal” id=“−1”>
        <bet>EST/RiskManagement/ELA</bet>
        <bet>EST/RiskManagement/ELA/Real EstateLiability</bet>
        <bet>EST/RiskManagement/ELA/ProductLiability</bet>
        <bet>EST/RiskManagement/ELA/OperationsLiability</bet>
</userclass>
- <userclass name=“Materials-design/process” id=“−1”>
        <bet>EST/PD</bet>
        <bet>EST/RO</bet>
        <bet>EST/RO/MaterialsManagement</bet>
        <bet>EST/RO/MaterialsManagement/Byproductreuse</bet>
        <bet>EST/RO/MaterialsManagement/SourceReduction</bet>
        <bet>EST/RO/MaterialsManagement/WasteMinimization</bet>
        <bet>EST/RO/MaterialsManagement/Recycling</bet>
        <bet>EST/RO/MaterialsManagement/Recycling/CollectionSystems</bet>
        <bet>EST/RO/MaterialsManagement/Recycling/ReprocessingEquipment</bet>
        <bet>EST/RO/MaterialsManagement/WasteExchanges</bet>
</userclass>
- <userclass name=“Materials-procurement” id=“−1”>
        <bet>EST/ProcurementSCEM</bet>
        <bet>EST/ProcurementSCEM/ProductionGoods</bet>
        <bet>EST/ProcurementSCEM/ProductionGoods/Utilities</bet>
        <bet>EST/ProcurementSCEM/ProductionGoods/Feedstocks</bet>
        <bet>EST/ProcurementSCEM/NonProductionGoods</bet>
        <bet>EST/ProcurementSCEM/Non ProductionGoods/Maintenance</bet>
        <bet>EST/ProcurementSCEM/Non ProductionGoods/Repair</bet>
        <bet>EST/ProcurementSCEM/NonProductionGoods/Operations</bet>
        <bet>EST/ProcurementSCEM/NonProductionGoods/Services</bet>
        <bet>EST/ProcurementSCEM/SupplierCertification</bet>
        <bet>EST/ProcurementSCEM/Audits</bet>
        <bet>EST/ProcurementSCEM/SupplierCertification/CertifiedMaterials</bet>
        <bet>EST/ProcurementSCEM/SupplierCollaboration</bet>
        <bet>EST/RO/MaterialsManagement</bet>
        <bet>EST/RO/MaterialsManagement/Recycling</bet>
        <bet>EST/RO/MaterialsManagement/WasteExchanges</bet>
        <bet>RES/Material</bet>
        <bet>RES/Material/Minerals</bet>
        <bet>RES/Material/ForestProducts</bet>
        <bet>RES/Material/ForestProducts/Paper</bet>
        <bet>RES/Material/ForestProducts/Packaging</bet>
        <bet>RES/Material/ForestProducts/Office</bet>
        <bet>RES/Material/ForestProducts/Wood</bet>
        <bet>RES/Material/Chemicals</bet>
        <bet>RES/Material/Chemicals/Solvents</bet>
        <bet>RES/Material/Chemicals/Lubricants</bet>
        <bet>RES/Material/Polymers</bet>
        <bet>RES/Material/Ceramics</bet>
        <bet>RES/Material/Metals</bet>
        <bet>RES/Material/Metals/Ferrous</bet>
        <bet>RES/Material/Metals/Nonferrous</bet>
        <bet>RES/Material/CompositesSpecialty</bet>
        <bet>RES/Material/Secondary</bet>
        <bet>RES/Material/Secondary/Minerals</bet>
        <bet>RES/Material/Secondary/ForestProducts</bet>
        <bet>RES/Material/Secondary/Chemicals</bet>
        <bet>RES/Material/Secondary/Polymers</bet>
        <bet>RES/Material/Secondary/Ceramics</bet>
        <bet>RES/Material/Secondary/Metals</bet>
        <bet>RES/Material/FinishedGoods</bet>
        <bet>RES/Material/ComponentParts</bet>
</userclass>
<userclass name=“Product Stewardship” id=“−1”>
        <bet>EST/PD</bet>
        <bet>EST/PD/PS</bet>
        <bet>EST/PD/PS/SalesMarketing</bet>
        <bet>EST/PD/PS/SalesMarketing/ProductDifferentiation</bet>
        <bet>EST/PD/PS/SalesMarketing/GreenMarketing</bet>
        <bet>EST/PD/PS/SalesMarketing/EnvironmentalCertification</bet>
        <bet>EST/PD/PS/SalesMarketing/ProductTakeback</bet>
        <bet>EST/PD/PS/ProductSafety</bet>
        <bet>EST/PD/PS/ToxicContent</bet>
        <bet>EST/PD/PS/DesignforRecycling</bet>
        <bet>EST/PD/PS/DesignforDisassembly</bet>
        <bet>EST/PD/PS/RecycledContent</bet>
        <bet>EST/PD/PS/EnergyConsumption</bet>
        <bet>EST/PD/PS/PackagingOptimization</bet>
        <bet>EST/PD/PS/PackagingOptimization/PrimaryPackaging</bet>
        <bet>EST/PD/PS/PackagingOptimization/SecondaryPackaging</bet>
        <bet>EST/PD/PS/ProductDistribution</bet>
</userclass>
- <userclass name=“Regulatory Compliance- Air” id=“−1”>
        <bet>RES/Air</bet>
        <bet>RES/Air/HazardousAirPollutants</bet>
        <bet>RES/Air/GHG</bet>
        <bet>RES/Air/CriteriaPollutants</bet>
        <bet>RES/Air/VOCs</bet>
</userclass>
- <userclass name=“Regulatory Compliance- Land” id=“−1”>
        <bet>RES/Land/Grounds/ContaminatedSites</bet>
    </userclass>
- <userclass name=“Regulatory Compliance- Water” id=“−1”>
        <bet>RES/Water/Usage</bet>
        <bet>RES/Water/Usage/Utility</bet>
        <bet>RES/Water/Usage/SurfaceWater</bet>
        <bet>RES/Water/Effluent</bet>
        <bet>RES/Water/Effluent/Conventional</bet>
        <bet>RES/Water/Effluent/Toxic</bet>
        <bet>RES/Water/Effluent/NonConventional</bet>
</userclass>
- <userclass name=“Risk Management” id=“−1”>
        <bet>EST/RiskManagement</bet>
        <bet>EST/RiskManagement/ELA</bet>
        <bet>EST/RiskManagement/ELA/RealEstateLiability</bet>
        <bet>EST/RiskManagement/ELA/ProductLiability</bet>
        <bet>EST/RiskManagement/ELA/OperationsLiability</bet>
        <bet>EST/RiskManagement/ScenarioAnalysis</bet>
        <bet>EST/RiskManagement/ScenarioAnalysis/EnergyPriceVolatility</bet>
        <bet>EST/RiskManagement/ScenarioAnalysis/Natural Disaters</bet>
</userclass>
- <userclass name=“Solid Waste mgt.” id=“−1”>
        <bet>RES/Waste</bet>
        <bet>RES/Waste/Nonhazardous</bet>
        <bet>EST/RO/WasteManagement</bet>
        <bet>EST/RO/WasteManagement/WasteExchanges</bet>
                    <bet>EST/RO/WasteManagement/WasteTracking</bet>
                      <bet>EST/PD/Process/SecondaryMaterialUse</bet>
                        <bet>EST/PD/Process/ByproductReuse</bet>
                                <bet>PRO/Disposal</bet>
        <bet>PRO/Disposal/Waste</bet>
        <bet>PRO/Disposal/WasteUndergroundInjection</bet>
        <bet>PRO/Disposal/Waste/Onsite</bet>
        <bet>PRO/Disposal/Waste/Offsite</bet>
        <bet>PRO/Disposal/Recycle</bet>
        <bet>PRO/Disposal/Recycle/Onsite</bet>
        <bet>PRO/Disposal/Recycle/Offsite</bet>
</userclass>
- <userclass name=“Supply Chain” id=“−1”>
        <bet>EST/ProcurementSCEM</bet>
        <bet>EST/ProcurementSCEM/ProductionGoods</bet>
        <bet>EST/ProcurementSCEM/ProductionGoods/Utilities</bet>
        <bet>EST/ProcurementSCEM/ProductionGoods/Feedstocks</bet>
        <bet>EST/ProcurementSCEM/NonProductionGoods</bet>
        <bet>EST/ProcurementSCEM/NonProductionGoods/Maintenance</bet>
        <bet>EST/ProcurementSCEM/NonProductionGoods/Repair</bet>
        <bet>EST/ProcurementSCEM/NonProductionGoods/Operations</bet>
        <bet>EST/ProcurementSCEM/NonProductionGoods/Services</bet>
        <bet>EST/ProcurementSCEM/SupplierCertification</bet>
        <bet>EST/ProcurementSCEM/Audits</bet>
        <bet>EST/ProcurementSCEM/SupplierCertification/CertifiedMaterials</bet>
        <bet>EST/ProcurementSCEM/SupplierCollaboration</bet>
        <bet>EST/RO/WasteManagement</bet>
</userclass>
- <userclass name=“Worker Health” id=“−1”>
        <bet>EST/HS/WorkerHealth</bet>
        <bet>EST/HS/WorkerHealth/injuriesLostDays</bet>
        <bet>EST/HS/WorkerHealth/ProtectiveEquipment</bet>
        <bet>EST/HS/WorkerHealth/IndoorAirQuality</bet>
        <bet>EST/HS/WorkerHealth/AccidentPrevention</bet>
        <bet>EST/HS/WorkerHealth/Training</bet>
        <bet>EST/HS/WorkerHealth/MSDS</bet>
        <bet>EST/HS/WorkerHealth/Ergonomics</bet>
        <bet>EST/HS/WorkerHealth/Ergonomics/RepetitiveMotion</bet>
        <bet>EST/HS/WorkerHealth/Ergonomics/Lifting</bet>
        <bet>EST/HS</bet>
</userclass>
</translation>
```

What is claimed is:

1. A system for receiving and transmitting data to a user, comprising:
a categorization engine to receive data from a client data source and at least one other data source, and to categorize the data by assigning a document content identifier to the data to describe a nature of the data;
a data record database to receive and to store the categorized data;
a structured database to receive the data from the client data source and to provide structured data;
a data mapping arrangement to map the categorized data by associating the assigned document content identifier to at least one of a user class and a task supplied by the user;
an application engine to apply system elements to the mapped data based on at least one of the user class and the task, and to determine a format for providing the data to the user data; and
a delivery arrangement to transmit data to the user.

2. The system of claim 1, wherein the at least one other data source includes a public data source and a private data source.

3. The system of claim 1, wherein the user class includes at least one of a role, an industry, and a business objective.

4. The system of claim 1, wherein the user class includes at least one of accounting, community relations, extremely hazardous substances, energy-process/operations, energy procurement, environmental marketing communications, facilities manager, facility safety, finance, green house gases, hazardous material management, information systems, investor relations, labor relations, legal, materials-design/process, materials procurement, product stewardship, regulatory compliance-air, regulatory compliance land, regulatory compliance water, risk management, solid waste management, supply chain, and worker health.

5. The system of claim 1, wherein the task includes at least one of complying with a regulation, a resource optimization, a risk assessment, a product design for a product, a supply chain management objective, a corporate strategy, and a corporate communication.

6. The system of claim 1, wherein the document content identifier is assigned based on user feedback provided to the categorization engine.

7. The system of claim 1, wherein the delivery arrangement is configured to retrieve data using a Boolean search based on the assigned document content identifier.

8. The system of claim 1, further comprising:
a data record indexing arrangement to apply the document content identifier;
a data source identification arrangement to identify a source of the data;
a data record source database to store the source of the data; and
a data record staging area to supplement the data and to provide the data to the categorization engine.

9. The system of claim 8, further comprising:
an expert domain arrangement to review the data for accurate content and proper assignment of the document content identifier.

10. The system of claim 8, wherein the document content identifier includes at least one of a content identifier, an entry date, a display name, an author, a creation date, a keyword, a description, a file name, a system element type, a presentation layer identifier, a data source, an actual date, an expert email address, a first 2000 indicator, a period covered, a target, an individual-or-group indicator, a benchmark, a resource, an environmental stewardship, a process, an issue, an industry sector, a geographic location.

11. The system of claim 8, wherein the supplemental data includes data based on at least one of the user feedback and a third party content provider.

12. The system of claim 8, further comprising:
a user interface to transmit the user class and the task, to trigger the application integration engine, and to provide feedback form the user; and
a mapping engine arrangement to map the categorized data based on the at least one of the user class and the task transmitted by the user interface;
wherein the application integration engine operable to receive the mapped data from the mapping engine arrangement, supplement the mapped data with the structured data, and apply system elements to format the data.

13. The system of claim 8, wherein the system elements include at least one of a news item, a research item, a metric, an expert, a workflow, a company document, a tool, a discussion forum, and a report item.

14. The system of claim 1, wherein the data is at least one of mapped and categorized according to environmental and organizational relevance.

15. A method for applying document content identifiers, the method comprising:
identifying one of a desired content and a content source;
retrieving data records relevant to one of the desired content and the content source;
batching and formatting the data records;
categorizing the data records by assigning a document content identifier;
reviewing the categorized data records via a domain expert; and
storing the data records in a database.

16. The method of claim 15, wherein the are retrieved via at least one of a web crawler and a third party provider.

17. A method for integrating data records of information, the method comprising:
transmitting a user class and a task;
mapping the data records based on the user class and the task;
integrating system elements and structured data with the mapped data records; and
delivering the mapped data records to a user of the user class.

18. A method for integrating data records of information, the method comprising:
transmitting a user class and a task;
mapping the data records based on the user class and the task;
integrating system elements and structured data with the mapped data records; and
delivering the mapped data records to a user of the user class.

19. A taxonomical system for categorizing data for deliver to user, comprising:
meta taxonomies to characterize the data according to a user class and a use of the information, each meta-taxonomy having hierarchically-arranged sub-structures dynamically modifiable in response to user feedback;
a categorization engine to receive the data from at least one data source and to categorize the data by assigning a document content identifier that describes a nature of the data;
a mapping arrangement to associate the assigned document content identifier with one of the meta taxonomies;
an application engine to apply at least one of structured data and system elements to determine a format for providing the data; and
a delivery arrangement to provide the data to the user without performing a search of a content of the data.

20. A taxonomical system for retrieving, labeling, and storing data for a user, comprising:
a categorization engine to retrieve the data from at least one data source and to categorize the data by assigning a document content identifier that describes a nature of the data;
a labeling arrangement to label the data according to at least one of a system element, a user class, and a task;
a memory arrangement to store the labeled data; and
a mapping arrangement to apply meta-data to the stored data to associate the stored data with one of the user class and the task.

21. The taxonomical system of claim 20, wherein the labeling arrangement is task-driven.

22. The taxonomical system of claim 20, wherein the labeled and mapped data establishes a basis for connecting the data to the user to assist in performing the task.

23. The taxonomical system of claim 20, further comprising:
a database for storing content meta-data categories to prepare the data for meta-data mapping.

24. The taxonomical system of claim 20, wherein the content meta-data categories are mutlitiered.

25. The taxonomical system of claim 20, wherein the content meta-data categories are hierarchically structured.
